(19) United States
(12) Patent Application Publication
(10) Pub. No.: US 2018/0035705 A1
(43) Pub. Date: Feb. 8, 2018

(54) COMPOSITIONS PROVIDING EXTENDED ENERGY AND METHODS OF USE

(71) Applicant: Blue Dragonfly, Inc., Henderson, NV (US)

(72) Inventor: Sue Ann ALTER, Encino, CA (US)

(73) Assignee: Blue Dragonfly, Inc., Henderson, NV (US)

(21) Appl. No.: 15/550,775

(22) PCT Filed: Feb. 12, 2016
(86) PCT No.: PCT/US2016/017787

§ 371 Date: Aug. 12, 2017

Related U.S. Application Data
(60) Provisional application No. 62/115,376, filed on Feb. 12, 2015.

(51) Int. Cl. A23L 33/175; A23L 33/105; A23L 2/52

(52) U.S. Cl. CPC A23L 33/175; A23L 2/52; A23L 33/105; A23V 2002/00

(57) ABSTRACT

Compositions that provide sustained energy up to 8 hours with an amount of caffeine that is less than 25 mg are described. The compositions comprise at least an astragaloside compound, a ginsenoside compound, a stilbenoid compound, and caffeine. Many of the compositions further comprise an amino acid having anabolic properties (e.g., having a role in the regulation of protein metabolism), including one or more of the group of arginine, ornithine, citrulline, glutamine, and a precursor, analog, prodrug, and/or derivative thereof, as well as molecules that interact with arginosuccinate synthase and/or arginosuccinate lyase, and analogs, prodrugs and derivatives thereof. Methods of utilizing the described compositions include administering orally to a subject an effective amount of the described composition, such that the composition provides sustained energy for up to 8 hours with an amount of caffeine in the composition administered orally that is less than 25 mg.

### CROSS REFERENCE TO RELATED APPLICATIONS

This application claims priority to U.S. Provisional Application No. 62/115,376 filed on Feb. 12, 2015, all of which is hereby incorporated by reference for all purposes.

### FIELD OF THE INVENTION

The invention describes novel compositions, provided at least as edible compositions, having extended energy when consumed. Said compositions further comprise a combination of components with unexpected synergistic activity when consumed.

### BACKGROUND

Energy products providing energy typically do so by including high doses of caffeine. Said products may also include one or more amino acids, such as those considered to promote metabolism and/or cellular performance. The level of caffeine in such products is typically greater than 70 mg, and may be as high as 100 mg, or more that 200 mg per serving. Said high doses of caffeine, however, may have unintended consequences. At higher doses caffeine can produce, for example, nervousness, anxiety and tachycardia. High caffeine levels can also lead to dependency. Reducing the unintended consequences associated with high dose caffeinated products would be of benefit, particularly as a health benefit for anyone consuming the high energy product.

Additives for improving cellular performance, such as amino acids, are not generally effected by the amount of caffeine. However, many amino acids, even when provided in high doses in an energy product are not absorbed but are excreted. This is found, for example, in energy products provided as drinks or that are for drinking. Enhancing the absorption of said additives, such as amino acids, would be of benefit, particularly as a health benefit for anyone consuming the high energy product. Furthermore, providing the energy product in a form that enhances overall absorption of all the components in the product would be of benefit.

There also remains a need for maintaining energy for an extended period, including providing the extended energy in a form that is not only palatable, is readily available for use by the body with improved bioavailability, is easily and readily administered, enhances performance, and reduces unintended consequences associated with many alternative energy products. These and other needs are met by the compositions described below.

### Overview

Described herein are novel compositions and uses for said novel compositions. Said compositions overcome one or more of the above described problems or obstacles. For example, the described novel compositions are in one or more forms palatable. The described novel compositions are in one or more forms readily available for use by the body. The described novel compositions have in one or more forms improved bioavailability. The described novel compositions are in one or more forms easily and readily administered. The described novel compositions will in one or more forms synergistically enhance and improve performance, including mental performance. The described novel compositions will in one or more forms synergistically provide or maintain or improve energy for an extended period, for up to and/or more than eight hours. The described novel compositions will in one or more forms synergistically improve mental clarity after consuming said novel compositions. The described novel compositions will in one or more forms synergistically improve memory after consuming said novel compositions. Said described improvements are found with the compositions described herein as compared with compositions not containing the described components in the described composition. Said described improvements are found with the compositions described herein as compared with compositions not containing one or more of the described components of the compositions described herein. The described novel compositions will in one or more forms synergistically reduce unintended consequences associated with many current or alternative energy products. These and other needs are met by the compositions described below.

The described novel compositions include in one or more forms a synergistically effective combination in an active portion, the active portion comprising at least an astragaloside compound, a ginsenoside compound, a stilbenoid compound, and caffeine, the active portion in an amount effective to synergistically increase the capability of at least one of the components in the active portion. In one or more embodiments, the astragaloside compound, the ginsenoside compound, the stilbenoid compound, and/or the caffeine are present in a composition an amount to effect the synergistic activity, such as an increase in absorption, and/or an increase bioavailability, and/or an increase local activity, and/or an biologic activity, and/or an increase in perception of an improvement of at least one of the components of the composition in a target, the target having obtained and/or having been administered said composition. The target may be a subject in need or desirous of an improvement, as described above. The astragaloside compound may be in an amount between about 0.1 wt. % and about 5 wt. % of the composition, or between about 0.1 wt. % and about 2.5 wt. % of the composition, or between about 0.5 wt. % and about 5 wt. % of the composition, or between about 0.5 wt. % and about 2.5 wt. % of the composition, or between about 0.1 wt. % and about 10 wt. % of the composition based on weight of the total composition, or in any range therebetween. The ginsenoside compound may be in an amount between about 0.1 wt. % and about 5 wt. % of the composition, or between about 0.1 wt. % and about 2.5 wt. % of the composition, or between about 0.5 wt. % and about 5 wt. % of the composition, or between about 0.5 wt. % and about 2.5 wt. % of the composition, or between about 0.1 wt. % and about 10 wt. % of the composition based on weight of the total composition, or in any range therebetween. The stilbenoid compound may be in an amount between about 0.1 wt. % and about 8 wt. % of the composition, or between about 0.1 wt. % and about 7.5 wt. % of the composition, or between about 0.1 wt. % and about 5 wt. % of the composition, or between about 0.1 wt. % and about 3 wt. % of the composition, or between about 0.5 wt. % and about 8 wt. % of the composition, or between about 0.5 wt. % and about 7.5 wt. % of the composition, or between about 0.5 wt. % and about 5 wt. % of the composition, or between about 0.5 wt. % and about 3 wt. % of the composition, or between about 0.1 wt. % and about 10 wt. % of the composition based on weight of the total composition, or in any range therebetween. The caffeine may be in an amount between about 0.1 wt. % and about 7.5 wt. % of the composition, or between about 0.1 wt. % and about 5 wt. % of the composition, or between about 0.1 wt. % and about 3 wt. % of the composition, or between about 0.1 wt. % and about 2.5 wt. % of the composition, or between about 0.5 wt. % and about 8 wt. % of the composition, or between about 0.5 wt. % and about 7.5 wt. % of the composition, or between about 0.5 wt. % and about 5 wt. % of the composition, or between about 0.5 wt. % and about 4 wt. % of the composition, or between about 0.5 wt. % and about 3 wt. % of the composition, or between about 0.5 wt. % and about 2.5 wt. % of the composition, or between about 0.1 wt. % and about 10 wt. % of the composition based on weight of the total composition, or in any range therebetween

In one or more forms are provided compositions having an active portion comprising an amino acid, a first combination and a second combination. The amino acid is, in one or more embodiments, an amino acid having anabolic properties (e.g., having a role in the regulation of protein metabolism). The amino may be provided as one or more of the group consisting of arginine, ornithine, citrulline, glutamine, and a precursor, analog, prodrug, and/or derivative thereof, as well as molecules that interact with arginosuccinate synthase and/or arginosuccinate lyase, and analogs, prodrugs and derivatives thereof. This amino acid may be in an amount between about 5 wt. % and about 50 wt. % of the composition, or between about 5 wt. % and about 30 wt. % of the composition, or between about 10 wt. % and about 50 wt. % of the composition, or between about 10 wt. % and about 25 wt. % of the composition, or between about 1 wt. % and about 50 wt. % of the total composition based on weight, or in any range therebetween. The first combination includes at least a combination of an astragaloside compound and a ginsenoside compound. The second combination is provided as a combination of a stilbenoid compound and caffeine. The composition may be for sublingual administration. The astragaloside compound may be extracted from Astragalus membranaceus, including variety mongholicus. The ginsenoside compound may be extracted from Panax natoginseng. The composition may be provided in a dry form for oral administration. The composition may be provided in a resinate form for oral administration. The composition may be provided in a gel form for oral administration. The composition may further comprise a sweetener. The stilbenoid compound may be pterostilbene. The composition may further comprise one or more excipients. An individual or single administration of the composition may have an amount of caffeine that is less than about 25 mg. An individual or single administration of the composition may have an amount of caffeine that is about or is less than about 20 mg. The composition may provide sustained energy up to about 8 hours with an amount of caffeine that is less than about 25 mg. The composition may provide sustained energy up to about 8 hours with an amount of caffeine that is or is less than about 20 mg. An individual or single administration of the composition (e.g., serving size) may be about 2 g. A single administration or individual administration of the composition may be about 4 g. An individual or single administration of the composition may be about 2.2 g. The amount of the astragaloside compound in the first combination may be up to about 15% based on the weight of the first combination. The ginsenoside compound in the first combination may be up to about 10% based on the weight of the first combination. The amount of the astragaloside compound and the ginsenoside compound in the first combination may make up about 95% of the first combination. The amount of the astragaloside compound in the first combination may be up to about 50% based on the weight of the first combination. The amount of the astragaloside compound in the first combination may be between about 40% and 50% of the first combination. The amount of the ginsenoside compound in the first combination may be between about 40% and 50% of the first combination. The amount of the ginsenoside compound in the first combination may be up to about 50% based on the weight of the first combination. The amount of the second combination in an individual or a single administration may be about 50 mg. The amino acid in an individual or a single administration may be in an amount that is between about 15 wt. % and about 40 wt. % based on the weight of the composition. The first combination in an individual or a single administration may be in an amount that is between about 0.5 wt. % and about 5 wt. % based on the weight of the composition. The first combination in an individual or a single administration may be in an amount that is between about 1 wt. % and about 4 wt. % based on the weight of the composition. In an individual or a single administration the composition may comprises from about 20 wt. % to about 50 wt. % of the active portion based on the weight of the individual or a single administration. The second combination may have a ratio of the caffeine to the stilbenoid compound in a range from about 40:60 to 50:50, or may be in a range from about 40:60 to 55:45. The second combination may be provided as a co-crystallized form of the stilbenoid compound and the caffeine. The composition may be formulated as a candy. The composition may be formulated as a drink. The composition may be formulated as a chewable. The composition may be formulated as a gum. The composition may be formulated as a gel. The composition may be formulated as a powder, such as one for dissolving in a liquid and for drinking.

A method of use of a composition is also described herein. The method comprises administering orally to a subject an effective amount of a composition. The composition may comprising at least an amino acid provided as one or more of the group consisting of arginine, an arginine precursor, citrulline, molecules that interact with arginosuccinate synthase and arginosuccinate lyase, and analogs and derivatives thereof. The composition may further comprise a first combination provided as a combination of an astragaloside compound and a ginsenoside compound. The combination may further comprise a second combination provided as a combination of a stilbenoid compound and caffeine. The composition may provide sustained energy up to about 8 hours with an amount of caffeine that is less than about 25 mg. The composition may provide sustained energy up to 8 hours with an amount of caffeine that is or is less than about 20 mg.

The compositions described herein may further comprise one or more excipients of fillers. The excipients or fillers may be selected to increase the rate of dissolution of the composition. The excipients may generally include one or more of a sugar alcohol, organic acid, alkalizing agent or pH buffering agent, absorbent or disintegrant or glidant, and effervescent agent. The excipients may further include one or more sweeteners and/or natural flavorings. The excipients or fillers may be provided in order that the compositions described herein are available for use or are in a form suitable for sublingual administration or sublingual delivery. Thus, in one or more embodiments, the compositions when fully formulated are rapidly absorbed by the oral mucosa after administration or delivery. The compositions when fully formulated may be provided in any of a number of forms for oral delivery, including but not limited to powder, resinate, waxate, losenge, wafer, gummy, gel, gum, tablet, capsule. In some embodiments, the compositions when fully formulated are provided as candy.

The compositions described herein, including any excipients or fillers, will be those Generally Recognized as Safe (GRAS) in accordance with the Federal Food, Drug and Cosmetic Act. The compositions described herein, including any excipients or fillers, will generally not include products prepared by or produced by genetically modified organisms.

The described compositions that include the described active portion are provided to a subject. The described compositions may be provided as a supplement. The subject may be one in need of energy. In some embodiments, when said composition is provided to the subject, the combination comprising the active portion exhibits a synergistic effect. The synergistic effect is considered an activity or effect that is greater than the activity or effect of said agents or compounds when used alone or separately. As such, each described composition when provided as a combination as described herein means that said composition may be provided at a same amount or at a lower amount or at a much lower amount than used for the ingredients when provided separately. The same or lower amount includes an amount that is the same or lower than current recommendations for use of at least one of the independent ingredients.

The compositions described herein and containing the components as described herein may be provided as the described composition, or some of the components may be provided independently, or may be provided sequentially, or may be provided concomitantly. Providing concomitantly may include providing together, such as in a blend, mixture, or same dose. Providing concomitantly may include providing simultaneously, or concurrently, or providing in parallel, such as at or about a same time or at or about a same schedule.

In some embodiments, effectiveness of at least one of the independent components (e.g., amino acid, astragaloside compound and a ginsenoside compound, stilbenoid compound and caffeine) is better or far better than when used independently. In some embodiments, the activity and/or effectiveness of the described compositions are far greater than would be predicted for a combination of two or more of the components, behaving synergistically.

These novel compositions may be provided in therapeutically acceptable amounts or orally effective amounts for providing energy to a subject or biologically effective amounts that provide energy to a subject, such as a subject in need of or desiring energy. The novel compositions may provide antioxidant effects in a subject, such as a subject in need thereof. The novel compositions may enhance amino acid absorption in the subject, such as a subject in need thereof.

In one or more forms are provided compositions having an active portion comprising an astragaloside compound (e.g., extracted from Astragalus membranaceus), a ginsenoside compound (e.g., extracted from Panax natoginseng), a stilbenoid compound, and caffeine. In addition, or as an alternative, the composition may further comprise an amino acid. The amino acid may be provided as one or more of the group consisting of arginine, an arginine precursor, citrulline, molecules that interact with arginosuccinate synthase and arginosuccinate lyase, and analogs, prodrugs and derivatives thereof. In addition, or as an alternative, the composition may further comprise an amino acid analog of a human or proteinogenic amino acid, such as an analog found in a plant or fungi, an example includes theanine. In addition, or as an alternative, the composition may further comprise niacin (vitamin B3), or a component having niacin and/or performing in a manner representative of niacin, such as a vitamin B3 metabolite, and/or nicotinamide riboside. In addition, or as an alternative, the composition may further comprise a beta-glucan. In addition, or as an alternative, the composition may further comprise a hyaluronic acid. In addition, or as an alternative, the composition may further comprise a glycoprotein and/or antibodies with o promoting activity in the immune system (e.g., inhibit tryptase enzymes, and/or block binding to protease-activity receptor 2). In addition, or as an alternative, the composition may further comprise one or more of a plant, tree, herb, or extracts thereof (e.g., from fruit, seed, bark, leaf, etc.), said plant, tree, herb, or extract, thereof, having one or more biologic actions when provided to or administered to a subject. Examples include but are not limited to an extract of Sceletium tortuosum, an extract from the Crocoideae family, an extract from Crocus (genus), an extract of Crocus sativus (e.g., saffron), an extract of saffron, an extract of Dichrostachys glomerata, an extract of Hypodaphnis zenkeri, an extract of Xylopia aethiopica, an extract from the Myricaceae family, an extract from the Myrica genus, an extract of Japanese arrowroot (e.g., Kudzu), an extract of Irvingia gabonensis, polyphenols from a plant, tree, herb, or extracts thereof, glutelins from a plant, tree, herb, or extract thereof, an extract from the Asteraceae family; and/or an extract from the Tagetes genus. In addition, or as an alternative, the composition may further comprise dimethylaminoethanol (DMAE), or dimethylethanolamine (DMEA), or a bitartrate salt thereof, or analogs, or suitable derivatives thereof. In addition, or as an alternative, the composition may further comprise dihydromyricetin. In addition, or as an alternative, the composition may further comprise a carotenoid, or carotenoid alcohol. In addition, or as an alternative, the composition may further comprise a xanthophyll, such as lutein. Any of the additional and/or alternative components may be used in combination. Any of the additional and/or alternative components may be provided in their biologically acceptable form, or as a biologically acceptable analog or derivative thereof.

Any of the composition described herein may include in a single administration of the composition an amount of the astragaloside compound, and/or the ginsenoside compound, and/or the caffeine, and/or the stilbenoid compound, in which each is about or less than about 10 wt. % of the composition, based on weight. In addition, in any of the compositions described herein, any of the astragaloside compound, and/or the ginsenoside compound, and/or the caffeine, and/or the stilbenoid compound, may be in an amount that is between about 0.5 wt. % and about 5 wt. % of the composition, based on a total weight of the composition.

Any of the compositions described herein, including compositions with any one or more of the additional and/or alternative ingredients described above, may be provided in an individual serving or a single administration, in which said individual serving or single administration may include an amount of caffeine that is less than about 25 mg, or may include an amount of caffeine that is at or less than about 20 mg. An individual serving or single administration of the composition may be in a solid form, gel form, liquid form, and various combinations thereof. An individual serving or single administration of the composition may be about 1.5 g, or about 2 g, or about 2.2 g, or about 2.5 g, or about 3.0 g, or about 3.5 g, or about 4 g, or in any other amount that could be ingestible or dilutable or provided as a single administration and/or as an individual serving. An individual serving or single administration of the composition may be about 100 milliliters (ml), or about 90 ml, or about 60 ml, or in any other amount that could be ingestible or dilutable or provided as a single administration and/or as an individual serving.

Any of the compositions described herein, including with any one or more of the additional and/or alternative ingredients, may be formulated as a candy, as a drink, as a chewable, as a gum, as a gel, as a crystal, as a powder, as a liquid, and suitable combinations thereof. In one or more embodiments, the formulation may be dissolve in a liquid. In one or more embodiments, the formulation may be for drinking.

### DETAILED DESCRIPTION

Although making and using various embodiments are discussed in detail below, it should be appreciated that as described herein are provided many inventive concepts that may be embodied in a wide variety of contexts. Embodiments discussed herein are merely representative and do not limit the scope of the invention.

The novel compositions described herein includes an active portion. The active portion includes a plurality of biologically active components that individually, each component on its own generally provides some bioactivity or biologic effect. In combination, said components behave synergistically. Unexpectedly, the synergistic effect may, in some embodiments, be greater than would be predicted.

The active portion generally includes at least some or all of the following components: an astragaloside compound, a ginsenoside compound, a stilbenoid compound, and caffeine. In some embodiments the active portion in the compositions described herein includes the astragaloside compound, the ginsenoside compound, the stilbenoid compound, and the caffeine. In one or more embodiments, the active portion includes at least some or all of the following: the astragaloside compound, the ginsenoside compound, the stilbenoid compound, the caffeine, and an amino acid.

When the active portion of the described novel composition includes at least an amino acid, the amino acid will include one having anabolic properties (e.g., having a role in the regulation of protein metabolism). This amino acid may be selected from one or more of the group consisting of arginine, ornithine, citrulline, glutamine, and a precursor, analog, prodrug, and/or derivative thereof, including salts, and esters, thereof, as well as molecules that interact with arginosuccinate synthase and/or arginosuccinate lyase, and suitable analogs, and derivatives thereof, including salts, esters or prodrugs thereof. The salts or esters may include a malate. The salts may include mono-salts, or di-salt (e.g., sodium, potassium, calcium, magnesium), as well as salts formed with amines. The analogues, derivatives, salts, or prodrugs, thereof are representatively illustrated but not limited to formula I (citrulline) and formula II (arginine).

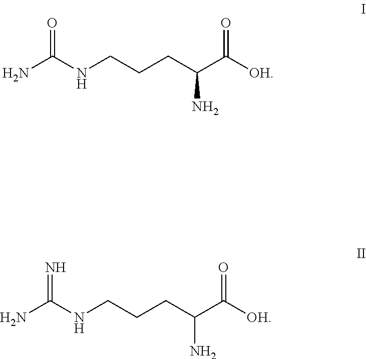 [SMILES: NC(=O)NCCC[C@H](N)C(=O)O ; N=C(N)NCCCC(N)C(=O)O]

The amino acid may be synthetic. The amino acid may be natural, or from a natural source. The amino acid may also be provided in a form that is an extract, or a juice, or from an extract or juice. For example, citrulline may be obtained from or extracted from watermelon. Arginine may be obtained from or extracted from, for example, dairy, beef, pork, gelatin, poultry, seafood, certain seeds, beans, grains, or nuts. Glutamine may be obtained from or extracted from, e.g., beef, pork, chicken, fish, eggs, milk, dairy, wheat, cabbage, beets, beans, spinach, parsley, or vegetable juices.

The amino acid may also include or be replaced by an amino acid analog of a human or proteinogenic amino acid, such as an analog found in a plant or fungi. An example is theanine, an amino acid analog of L-glutamate, and L-glutamine. Additional amino acids that may be included are glycine and/or methionine, as examples (e.g., arginine forms creatine with glycine and methionine).

In one or more embodiments, with an amino acid in the composition, the amino acid will comprise up to about 45 wt. % of a final composition, when prepared, such as for an individual administration. In some embodiments, the amino acid will comprise no more than 40% by weight of the final composition when prepared for an individual administration. In some embodiments, the amino acid will comprise about or less than about 35% by weight of the final composition when prepared for an individual administration, or about or less than about 30% by weight of the final composition when prepared for an individual administration, or about or less than about 29% by weight of the final composition when prepared for an individual administration, or about or less than about 28% by weight of the final composition when prepared for an individual administration, or about or less than about 27% by weight of the final composition when prepared for an individual administration, or about or less than about 26% by weight of the final composition when prepared for an individual administration, or about or less than about 25% by weight of the final composition when prepared for an individual administration, or about or less than about 20% by weight of the final composition when prepared for an individual administration, or about or less than about 15% by weight of the final composition when prepared for an individual administration, or about or less than about 12.5% by weight of the final composition when prepared for an individual administration. In some embodiment, the composition includes at least a first amino acid (e.g., one or more of the group consisting of arginine, an arginine precursor, citrulline, molecules that interact with arginosuccinate synthase and/or arginosuccinate lyase, and suitable analogs, and derivatives thereof, including salts, esters or prodrugs thereof) that is in an amount from a range of between about 10% by weight and about 45% by weight, or is in an amount from a range of between about 10% by weight and about 35% by weight, or is in an amount from a range of between about 10% by weight and about 30% by weight. In some embodiment, the composition includes, or further comprises, at least a second amino acid (e.g., amino acid analog of a human or proteinogenic amino acid, such as an analog found in a plant or fungi) that is in an amount from a range of between about 1% by weight and about 5% by weight, or is in an amount from a range of between about 1% by weight and about 4% by weight.

Generally, up to about 1000 mg of the amino acid is included in the described composition, such as for a single administration, or an individual serving. In some embodiments, the amino acid may be in an amount by weight that is up to about 500 mg, such as 10 mg, or 20 mg, or 50 mg, or 100 mg, or 150 mg, or 200 mg, or 250 mg, or 300 mg, or 350 mg, or 400 mg, or 500 mg, or in any range there between. In further embodiments the amino acid may be in an amount that is between about 200 mg and about 1000 mg, such as 200 mg, or 250 mg, or 300 mg, or 350 mg, or 400 mg, or 500 mg, or 550 mg, or 600 mg, or 650 mg, or 700 mg, or 750 mg, or 800 mg, or 850 mg, or 900 mg, or 950 mg, or in any range there between. Said amounts are suitable for an individual dose or for a single administration, such as when the each single administration or individual dose is, for example, about 1.5 g, or about 2 g, or about 2.2 g, or about 3 g, or about 4 g, more or less, or is about 60 ml, or about 90 ml, or about 100 ml, or more or less. The amount of the amino acid may be lower than an amount typically found in an energy product or energy supplement, which can often be, for example, as much as 1600 mg of the amino acid (such as citrulline) per administration, or even 2000 mg of the amino acid (such as citrulline) per administration, or more than 2000 mg of the amino acid per administration. The amino acid amounts described herein are generally much lower than the amounts found in supplements that are designed to provide supplemental amounts of amino acids to a subject. The amino acids are absorbed better, or are more effectively absorbed, with the compositions described herein (as compared with compositions that do not include the active components described herein). In some embodiments, the amino acid is provided in a dry form, such as a powder.

The active portion of the described novel composition includes an astragaloside compound, and a ginsenoside compound. In one or more embodiments, the active portion of the compositions described herein include some or all of the active portion provided in a first combination, in which the first combination includes at least the astragaloside compound, and the ginsenoside compound. In some embodiments, the first combination of the active portion may be a blend of the astragaloside compound, and the ginsenoside compound.

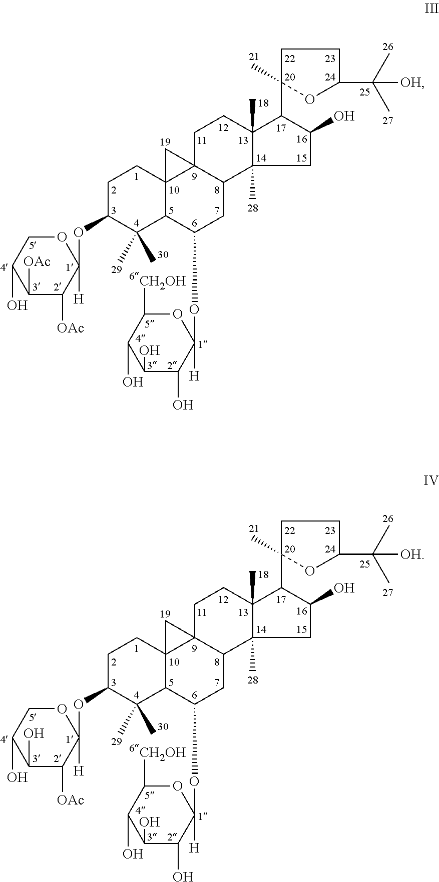

The astragaloside compound may be natural (e.g., obtained or otherwise extracted or isolated from a natural source) or synthetic. The astragaloside compound will generally comprise a cycloartane compound. Representative examples of the cycloartane compound are provided as formula III and formula IV.

In some embodiments, the astragaloside compound is extracted and obtained from a root, namely, from Astragalus membranaceus, including variety mongholicus, with an ethanol and water extraction method that may be followed by further purification steps and vacuum drying.

In one example, the astragaloside compound is isolated from the root of Astragalus membranaceus variety mongholicus as the cycolartane compound of Formula V.

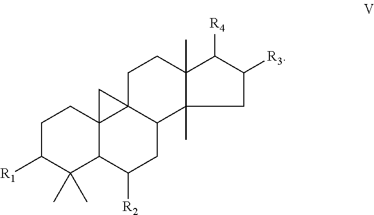

R₁ is selected from H, OH, O-acetyl, O-xylopyranosyl, O-(2-acetylxylopyranosyl), O-(3-acetylxylopyranosyl), O-(2,3-diacetylxylopyranosyl), O-(2,4-diacetylxylopyranosyl), O-xylopyranosyl-(1-2)-β-D-glucopyranosyl and O-xylopyranosyl-(1-2)-α-arabinopyranosyl; R₂ is selected from H, OH, O-acetyl and O-glucopyranosyl, O-xylopyranosyl; R₃ is selected from H, OH and O-acetyl; and R₄ is selected from structures A, B, C, D, E, F.

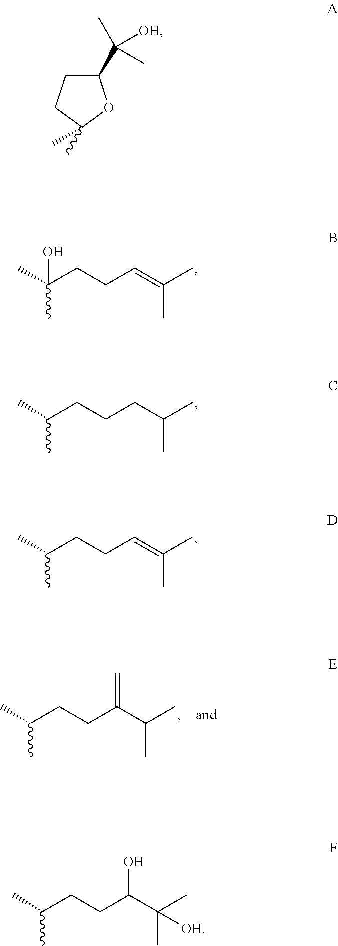

Isolation from the root of the Astragalus membranaceus variety mongholicus includes grinding the root, extracting ground materials with alcohol, separating and then purifying the alcohol extract (e.g., with silica gel and reverse phase chromatography) to provide the cycloartane astragaloside compounds, such as depicted in formula III, IV, and V. Some cycloartane astragaloside compounds may be further hydrolyzed (e.g., using naringinase, which may be used with any of the components described herein) to provide alternative cycloartane astragaloside compounds, as metabolites. Preparation of useful astragaloside cycloartane compounds obtained from Astragalus membranaceus variety mongholicus is described at least in U.S. Pat. No. 8,197,860, which is incorporated herein by reference in its entirety, which also provides additional exemplary analogs and derivatives of the compound, and provides some of the astragaloside compounds and methods of obtaining them, including some of the preferred compounds, and/or processing methods.

As described herein, the astragaloside compound in the active portion will, in one or more embodiments, at least enhance transport of the described amino acid (e.g., via absorption by certain cells after delivery or administration of the active portion comprising the astragaloside compound). Facilitative transport of other nutrients and/or components may also be enhanced by the astragaloside cycloartane compound.

The ginsenoside compound may be natural (e.g., obtained or otherwise extracted or isolated from a natural source) or synthetic. The ginsenoside compound will generally comprise a dammarane compound. Representative examples of the dammarane compound are provided as formula VI and formula VII.

In some embodiments, the ginsenoside compound is extracted and obtained from a root of a plant, namely, from Panax natoginseng, by an ethanol and water extraction method, which may be followed by further purification steps and vacuum drying.

In one example, the ginsenoside compound is isolated from the root of Panax natoginseng as the dammarane compound of formula VIII, in which R₁ is selected from H, acetyl, glucopyranosyl, glucopyranosyl-(2-1)-β-D-glucopyranosyl, glucopyranosyl-(2-1)-β-D-xylopyranosyl and glucopyranosyl-(2-1)-β-D-glucopyranosyl-(6-1)-xylopyranosyl; R₂ is selected from H, acetyl, glucopyranosyl, glucopyranosyl-(6-1)-β-D-glucopyranosyl, glucopyranosyl-(6-1)-β-D-xylopyranosyl, glucopyranosyl-(6-1)-α-L-arabinopyranosyl and glucopyranosyl-(6-1)-α-L-arabinofuranosyl; R₃ is selected from H, hydroxy, O-acetyl, O-β-D-glucopyranosyl, O-β-D-glucopyranosyl-(2-1)-β-D-glucopyranosyl, O-β-D-glucopyranosyl-(2-1)-β-D-xylopyranosyl and O-β-D-glucopyranosyl-(2-1)-α-L-rhamnopyranosyl; and R₄ is selected from H, hydroxyl and O-acetyl.

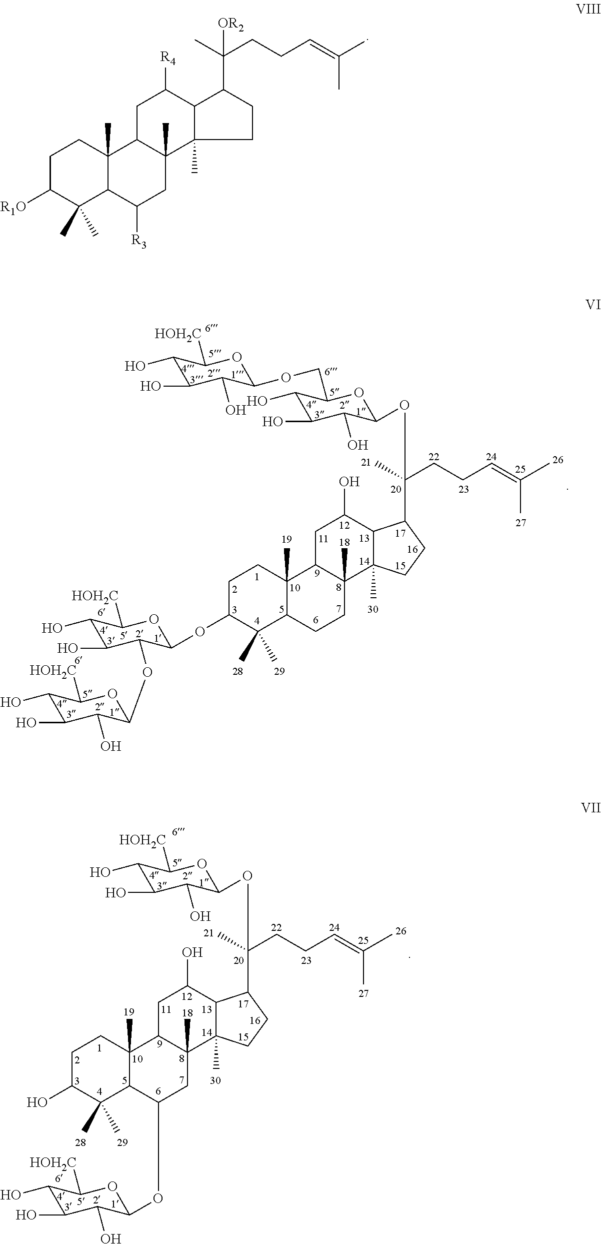

Isolation from the root of Panax natoginseng includes grinding the root, extracting ground materials with alcohol, separating and then purifying the alcohol extract (e.g., with silica gel and reverse phase chromatography) to provide the dammarane ginsenoside compounds, such as depicted in formula VI, VII, VIII. Some dammarane ginsenoside compounds may be further hydrolyzed (e.g., compounds of formula VI, VII, using naringinase) to provide alternative dammarane compounds, as metabolites. A method of preparing useful ginsenoside dummarane compounds from Panax natoginseng is described at least in U.S. Publication No. 20060293255, which is incorporated herein by reference in its entirety, and provides some ginsenoside compounds and methods of obtaining them, some of which may be preferred. The publication also provides further exemplary analogs and derivatives thereof of the ginsenoside compound.

As described herein, the ginsenoside compound will, in one or more embodiments, at least enhance facilitate transport of the described amino acid (e.g., via absorption by certain cells after delivery or administration of the active portion comprising the ginsenoside compound). Facilitative transport of other nutrients and/or components may also be enhanced by the ginsenoside compound.

When the ginsenoside compound and the astragaloside compound are provided in a first combination of the active portion, this first combination may include the astragaloside compound in an amount by weight that is up to about 50% of the first combination, and the ginsenoside compound in an amount that is also up to about 50% of the first combination. In some embodiments, the astragaloside compound may be in an amount that is between about 10% and 50%, as provided in the first combination. The astragaloside compound may be in an amount that is about 40 to 50% of the first combination, or is about 45%, or about 46%, or about 47%, or about 48%, or is about 49% of the first combination. Similarly, the ginsenoside compound may be in an amount that is between about 10% and 50%, %, as provided in the first combination. The ginsenoside compound may be in an amount that is about 40 to 50% of the first combination, or is about is about 45%, or about 46%, or about 47%, or about 48%, or is about 49% of the first combination. When a combination of the ginsenoside compound and the astragaloside compound are provided in a combination (first combination), and when the combination, together, is less than 100%, the balance may be provided by an excipient, such as an absorbent or disintegrant, and/or a sweetener. The additional or balance components (those in the first combination of the ginsenoside compound and the astragaloside compound) may be those provided for or useful for oral preparations. The additional or balance components (i.e., excipient) may comprise only about 10%, or less than 10%, or about 5%, or less than 5% of the first combination. A suitable example of an excipient is maltodextrin (preferably GMO free), which may also serve in part as an energy source, by having a high glycemic index. In some embodiments there may be a higher amount of the astragaloside compound than the ginsenoside compound when these are provided together in a first combination. In some embodiments there may substantially the same amount of the astragaloside compound and the ginsenoside compound when these are provided together in a first combination.

In some embodiments, the astragaloside compound and the ginsenoside compound in the first combination are in a blend, the combined compounds pre-blended so that the combined astragaloside and ginsenoside compounds together make up about 50 to 95% of the pre-blend, the balance being provided by the excipient. In some embodiments, the pre-blend may include approximately or substantially the same extract amount by weight of the astragaloside compound, and the ginsenoside compound. In some embodiments, the astragaloside compound and the ginsenoside compound may comprise 90% or more of the first combination. In some embodiments, the astragaloside compound and the ginsenoside compound may comprise 95% or more of the first combination. In some embodiments, the astragaloside compound, and the ginsenoside compound are provided independently.

When prepared for an individual dose or for a single administration, the astragaloside compound and the ginsenoside compound, whether provided independently or as the first combination, may each make up about or less than about 10%, or about or less than about 8%, or about or less than about 5%, or about or less than about 3%, or about or less than about 2% of the final composition, such as when the individual administration or the single administration is, for example, about 1.5 g, or about 2 g, or about 2.2 g, or about 3 g, or about 4 g, or more, or is about 60 ml, or about 90 ml, or about 100 ml, or more, which are suitable but non-limiting examples. The astragaloside compound and the ginsenoside compound, whether provided independently or as the first combination (e.g., pre-blend) may together make up about or less than about 15% of the final composition when prepared for the individual dose or the single administration, or may make up less than 10% of the final composition when prepared for the individual dose or single administration, or may make up less than 6% of the final composition when prepared for the individual dose or single administration, or may make up less than 5% of the final composition when prepared for the individual dose or single administration, or may make up less than 4% of the final composition when prepared for the individual dose or single administration, or may make up less than 3% of the final composition when prepared for the individual or single administration, or may make up less than 2% of the final composition when prepared for the individual or single administration, or may be in any range there between. As an example, when in a pre-blend, in which the astragaloside and ginsenoside compounds together make up about 95% or between about 90% and 95% of the pre-blend, a total amount by weight of the first combination that makes up the novel composition for each individual administration (e.g., an administration of, for example, any of the amounts described herein) may be up to or about 200 mg, or may be up to or about 150 mg, or may be up to or about 100 mg, or may be up to or about 75 mg, or may be up to or about 50 mg, or may be up to or about 25 mg, or may be less than about 50 mg, or some range there between. Similarly, when the astragaloside compound and the ginsenoside compound are provided independently, the astragaloside compound and the ginsenoside compound may comprise up to about 10% of the final composition, or may comprise up to about 9% of the final composition, or up to about 8% of the final composition, or up to about 7% of the final composition, or about or up to about 5% of the final composition, or about or up to about 4% of the final composition, or about or up to about 3% of the final composition, or about or up to about 2% of the final composition. In some embodiments, the astragaloside compound and the ginsenoside compound, whether provided independently or as the first combination, may be in an amount by weight that is between about 0.5% and 5% of the composition, based on the weight of the composition.

In one or more embodiments, the astragaloside compound and the ginsenoside compound, whether provided independently or as the first combination, may make up about 2% to about 10% of the active portion by weight. The active portion may comprise about 18% to about 44% by weight of the final formulation, provided in dry or liquid form. In many embodiments, when the amino acid is included in the formulation, and the amino acid comprises about or more than about 40%, or about or more than about 45% of the active portion by weight, the astragaloside compound and the ginsenoside compound, whether provided independently or as the first combination, generally make up about 2% to about 10% of the active portion by weight (in which the active portion comprises about 18% to about 44% by weight of the final formulation). This may occur when the amino acid is one or more of the group consisting of arginine, an arginine precursor, citrulline, molecules that interact with arginosuccinate synthase and/or arginosuccinate lyase, and suitable analogs, and derivatives thereof, including salts, esters or prodrugs thereof.

In some embodiments, when the amino acid is included in the formulation, and the amino acid is the amino acid analog of a human or proteinogenic amino acid, such as an analog found in a plant or fungi, the astragaloside compound and the ginsenoside compound, whether provided independently or as the first combination, may make up about 35% to about 50% by weight of the active portion by weight, such as in embodiments in which the active portion comprises no more than 10% by weight of the final formulation, or no more than 15% by weight of the final formulation. In some embodiments, when no amino acid is included in the formulation, the astragaloside compound and the ginsenoside compound, whether provided independently or as the first combination, may make up about 15% to about 30% of the active portion by weight, such as in embodiments in which the active portion comprises up to about 20% by weight of the final formulation, or between about 4% by weight and up to about 15% or 20% of the final formulation.

A representative example that provides a combination of the astragaloside compound and the ginsenoside compound (e.g., for the first combination) is AstraGin® (registered with Nuliv Science USA, Inc., California, USA), which contains between about 45% to 50% of each, or, in some embodiments, about 47.5% of the astragaloside compound extracted from Astragalus membranaceus variety mongholicus, and about 47.5% of the ginsenoside compound extracted from Panax natoginseng, and 5% maltodextrin. When used for the first combination, up to about 100 mg may be included in the novel composition when it is provided for an individual administration, or a single administration. In some embodiments, the amount by weight may be up to about 50 mg, or may be up to about 25 mg. Any of said amounts would be suitable for an individual oral dose or for a single oral administration, such as when the single or individual oral administration or individual oral dose is in any of the amounts described herein, such as, for example, about 1.5 g, or about 2 g, or about 2.2 g, or about 3 g, or about 4 g, or more or less, or is about 60 ml, or about 90 ml, or about 100 ml, or more or less, said examples provided as suitable but non-limiting examples.

In one or more embodiments, the compositions described herein, or the active portion thereof, further comprises a stilbenoid compound and caffeine. The stilbenoid compound and the caffeine may be provided independently, or may be co-combined to form a second combination. In one or more embodiments, the active portion of the compositions described herein includes some or all of the active portion provided in the second combination, in which the second combination includes at least the stilbenoid compound and the caffeine.

The stilbenoid compound may be natural or synthetic. In some embodiments, the stilbenoid compound is a non-ionizable methylated structural analog of resveratrol, depicted in formula IX as pterostilbene.

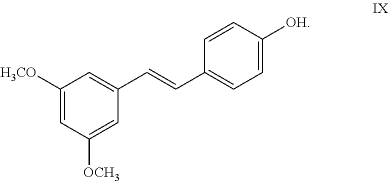 [SMILES: COc1cc(/C=C/c2ccc(O)cc2)cc(OC)c1]

In some embodiments, the stilbenoid compound has a skeleton or base (monomeric) structure that is based on a stilbenoid glucoside, such as piceid, as depicted in formula X.

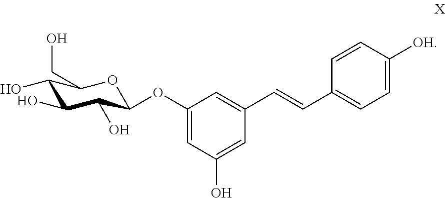

In some embodiments, the stilbenoid compound has a skeleton or base structure that is based on resveratrol, as depicted in formula XI.

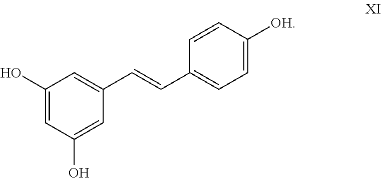 [SMILES: Oc1ccc(/C=C/c2cc(O)cc(O)c2)cc1]

In some embodiments, the stilbenoid compound has a skeleton or base (monomeric) structure that is based on piceatannol, as depicted in formula XII.

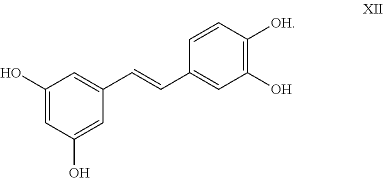 [SMILES: Oc1cc(O)cc(/C=C/c2ccc(O)c(O)c2)c1]

The stilbenoid compound may be derived from a plant family, such as Vitaceae, Dipterocarpaceae, Gnetaceae, Pinaceae, Fabaceae, Poaceae, Leguminoseae, Polygonaceae, and Cyperaceae, as examples. The stilbenoid compound may be a natural compound, or synthetic form of the natural compound, including but not limited to trans-piceid, cis-piceid, trans-resveratroloside, cis-resveratroloside, trans-astringin, cis-astringin, trans-resveratrol, cis-resveratrol, trans-pterostilbene, cis-piceatannol, trans-piceatannol, trans-pinosylvin, trans-pinosylvin-O-methyl ether, trans-pterostilbene, cis-pterostilbene, and any suitable combination thereof. Pterostilbene, as an example, or suitable polymorphs, analogs, derivatives or prodrugs thereof, may be used as the stilbenoid compound in the second combination. Pterostilbene is found and extracted from a variety of natural sources, including but not limited to tree bark, and small berries (e.g., blueberries, grapes). Pterostilbene and the related analogs and derivatives are phytoalexins that act as an antioxidant, and may provide other actions (e.g., anti-cancer activity, lowering triglyceride levels, as examples). The stilbenoid compound will have at least one biologic function found to be associated with the family, and may include chemically related or functional equivalents having the at least one biologic function including but not limited to antioxidant, antimicrobial, anticarcinogenic, radical scavenging, chemosensitization or chemoprevention, induction of apoptosis, anti-inflammatory, antifungal, deterrent, repellent, skin protectant, influence in microorganism resistance, lipid control, blood glucose control. Biologic function may also include acting as a phytoalexin. The stilbenoid compound, whether provided independently or in the second combination, should be one considered to exhibit some antioxidant effect (e.g., when examined in vitro on one or more cells). The stilbenoid compound should also provide positive effects on mental clarity and/or memory. The crystalline forms may be used, which may provide improvements in bioavailability and/or absorption, as well as dissolution and solubility, as compared with the amorphous forms.

In one or more embodiments, the stilbenoid compound, such as pterostilbene, is preferably provided in a crystalline form. The stilbenoid compound, such as pterostilbene, may be provided as a co-crystal with the caffeine. In an individual administration, the amount by weight of the stilbenoid compound in a final composition will generally not exceed 70 mg. In some embodiments, the stilbenoid compound may be in an amount that is less than about 70 mg per individual administration, or less than about 65 mg per individual administration, or about or less than about 50 mg per individual administration, or about or less than about 40 mg per individual administration, or about or less than about 30 mg per individual administration, or about or less than about 25 mg per individual administration, or about or less than 20 mg per individual administration, or about or less than 15 mg per individual administration, or about or less than 10 mg per individual administration, or about or more than about 5 mg per individual administration.

In some embodiments, the amount by weight of the stilbenoid compound in a composition described herein when formulated is about, or is somewhat greater, or is greater than the amount by weight of caffeine (e.g., greater than caffeine by about 8%, or about 9%, or about 10%, or about 11%, or about 12%, or about 13%, or about 14%, or about 15%, or about 16%, or about 17%, or about 18%, or about 19%, or about 20%, or more). In some but not all embodiments, the amount by weight of caffeine in a composition described herein when formulated is somewhat less, or is less than the amount by weight of the ginsenoside compound (e.g., less than ginsenoside by about 5%, or about 6%, or about 7%, or about 8%, or about 9%, or about 10%). In some but not all embodiments, the amount by weight of caffeine in a composition described herein when formulated is somewhat less, or is less than the amount by weight of the astragaloside compound (e.g., less than astragaloside by about 5%, or by about 6%, or by about 7%, or by about 8%, or by about 9%, or by about 10%, or by more) In some but not all embodiments, the amount by weight of the stilbenoid compound in a composition described herein when formulated is about, or is somewhat greater, or is greater than the amount by weight of ginsenoside compound (e.g., greater than ginsenoside by about 4%, or about 5%, or about 6%, or about 7%, or about 8%, or about 9%, or about 10%, or about 11%, or about 12%, or about 13%, or about 14%, or about 15%, or more). In some but not all embodiments, the amount by weight of the stilbenoid compound in a composition described herein when formulated is about, or is somewhat greater, or is greater than the amount by weight of astragaloside compound (e.g., greater than astragaloside by about 4%, or about 5%, or about 6%, or about 7%, or about 8%, or about 9%, or about 10%, or about 11%, or about 12%, or about 13%, or about 14%, or about 15%, or more).

When the stilbenoid compound is in the second combination, the stilbenoid compound, such as pterostilbene, is combined with caffeine. This combination is generally in a weight ratio in which the caffeine to the stilbenoid compound in the second combination is in a range from about 30:70 to 60:40, or may be in a range from about 40:60 to 55:45. In some embodiments, the molar ratio of the two components (stilbenoid compound and caffeine) in the second combination is about 1:1, or near 1:1. In some embodiments, the second combination includes both the stilbenoid compound and the caffeine in a powder form. The two components in the second combination may be provided independently, in which at least the pterostilbene is in a crystalline form. In some embodiments, the two components (as the second combination) may be co-crystallized.

In one embodiment, co-crystals of pterostilbene (as an example of the stilbenoid compound) with caffeine are prepared. In these examples, co-crystals may be prepared with the pterostilbene (in dry form) and the caffeine (in dry form). The amounts may be in a 1:1 molar ratio or may include more pterostilbene than caffeine or may consist of more caffeine than pterostilbene (e.g., 1.1:0.9 or 1.2:0.8, or 0.8:1.2, or 1.1:0.9). In one example, a mixture of the pterostilbene as an example of the stilbenoid compound) and the caffeine is prepared and then the mixture is ground, such as in milling jar, preferably with addition of a solvent (e.g., chloroform, acetonitrile, ethanol, nitromethane). Grinding should occur at a consistent frequency, (e.g., 30 Hz) at for some period of time (e.g., 10 to 30 minutes, or 20 minutes), after which solid crystals are formed. Alternatively, a solvent-based preparation includes adding solid caffeine to a nearly saturated solution of pterostilbene in a solvent (e.g., ethanol) followed by stirring or agitation for an extended period (e.g., 12 to 48 hours). Solid crystals are formed after stirring or agitating; stirring or agitating with or without heat. The solid crystals may be filtered and/or redissolved in solvent when too sticky, or when forming something that resembles more of a film. Single crystals may also be grown by vapor diffusion; the pterostilbene and the caffeine are dissolved in a minimal amount (weight to volume) of solvent (e.g., methanol) in a small vial, the vial being placed uncapped in a larger vial containing water, and capping the larger vial for an extended time (e.g., 1 day, 2 days, 3 days, etc.) until crystals are formed (may be rod shaped, prism shaped, etc.). Said crystals are harvested, comprising the co-crystalline form of pterostilbene and caffeine for the second combination. Representative x-ray powder diffraction patterns for certain useful co-crystals, and methods for preparing useful co-crystals are provided in U.S. Pat. No. 8,318,807, U.S. Pat. No. 8,399,712, U.S. Pat. No. 8,415,507, U.S. Pat. No. 8,513,236, each of which is incorporated herein by reference in its entirety. Examples of polymorphs of pterostilbene are described in WO 20100141107, which is herein incorporated by reference in its entirety.

The caffeine described herein is provided generally as a xanthine alkaloid, or a methylated form (methyl xanthine alkaloid), or derivatives thereof, such as guaranine, mateine, and/or theine. Further non-limiting examples include but are not limited to theobromine, theophylline and a synthetic analog aminophylline (theophylline ethylenediamine) (with or without methylation). Esters and salts thereof may comprise a malate. The caffeine is not limited to an anhydrous powder form, any salt or derivative of caffeine, as described above, or an equivalent, including a compounded equivalent that is non-toxic, and pharmaceutically acceptable, may be used. The caffeine, or its equivalent, should bind to adenosine receptors, antagonize certain adenosine receptors, and/or increase levels of cyclic AMP. In addition or as an alternative, plant sources of caffeine may be provided, such as from guarana, kola nut, Yerba mate, green or black tea, and/or cacao pods. In total, the amount by weight of caffeine in a final composition will generally not exceed 70 mg in an individual administration. The caffeine content may also be at or less than 65 mg per individual administration. The caffeine content may be at or less than 50 mg per individual administration, or at or less than 40 mg per individual administration, or at or less than 30 mg per individual administration, or at or less than 25 mg per individual administration, or at or less than 20 mg per individual administration, or at or less than 15 mg per individual administration, at or less than 10 mg per individual administration, or at or less than 5 mg per individual administration. Said caffeine amounts described herein are substantially less than amounts by weight found in alternative products that are designed to provide energy to an individual from a single administration or dose. Yet, the novel compositions described herein are found to provide energy for extended periods of time, said periods of time extending beyond what is found in the alternative products, in which said alternative products have more caffeine than described herein or have about the same amount of caffeine as provided in the novel compositions described herein.

In one or more embodiments, the stilbenoid compound and the caffeine make up the primary constituents in the second combination, such that the caffeine may comprise up to 50% of the second combination, based on weight, and the stilbenoid compound may comprise greater than 50% of the combination, based on weight. In one or more embodiments, the stilbenoid compound and the caffeine make up the primary constituents, or are the active constituents in the second combination, such that the caffeine may comprise up to about or about 50% of the second combination, based on weight, and the stilbenoid compound may comprise about or greater than about 50% of the second combination, based on weight. Said amounts are suitable for an individual dose or for a single administration, such as when the single administration or individual dose is in the amounts described herein. In some embodiments, the stilbenoid compound and the caffeine are pre-combined, such as in a co-crystalline form. When prepared pre-combined and then formulated for an individual dose for a single administration, the pre-combined amount by weight may make up less than 10% of the final composition. In some embodiments, the pre-combined amount may make up about or less than about 9% of the final composition when prepared for the individual administration or the single administration, or it may make up about or less than about 8% of the final composition when prepared for the individual or the single administration, or may make up about or less than about 7% of the final composition when prepared for the individual or the single administration, or may make up about or less than about 6% of the final composition when prepared for the individual or the single administration, or may make up about or less than about 5% of the final composition when prepared for the individual or the single administration, or may make up about or less than about 4% of the final composition when prepared for the individual or the single administration, or may make up about or less than about 3% of the final composition when prepared for the individual or the single administration, or may make up about or less than about 2% of the final composition when prepared for the individual or the single administration, or may be in any range there between. As an example, when pre-combined, such as when the stilbenoid compound and the caffeine compound are provided together (e.g. co-crystallized), the pre-combined amount that makes up the second composition for the individual or the single administration in the amounts described herein may be up to about 150 mg, or may be about or up to about 100 mg, or may be about or up to about 75 mg, or may be about or up to about 50 mg, or may be about or up to about 25 mg, or may be less than 50 mg, or in any range there between. When the stilbenoid compound and the caffeine compound are provided independently, the stilbenoid compound and the caffeine compound may comprise up to about 10% of the final composition, or may comprise up to about 9% of the final composition, or up to about 8% of the final composition, or up to about 7% of the final composition, or about or up to about 5% of the final composition, or about or up to about 4% of the final composition, or about or up to about 3% of the final composition, or about or up to about 2% of the final composition. In some embodiments, the stilbenoid compound and the caffeine compound, whether provided independently or as the first combination, may each in an amount that is between about 0.5% and 5% of the composition when formulated, or in an amount that is between about 0.5% and 5% of the composition when formulated, based on the weight of the composition.

In one or more embodiments, the stilbenoid compound and the caffeine, whether provided independently or as the second combination, may make up about 1% to about 12% of the active portion by weight, in which the active portion may comprise about 16% to about 46% by weight of the final formulation, in which the formulation is provided in dry or liquid form. In many embodiments, when the amino acid is included in the formulation, and the amino acid comprises about or more than about 40%, or about or more than about 45% of the active portion by weight, the stilbenoid compound and the caffeine, whether provided independently or as the second combination, generally make up about 1% to about 12% of the active portion by weight (in which the active portion comprises about 16% to about 46% by weight of the final formulation). This may occur when the amino acid is one or more of the group consisting of arginine, ornithine, citrulline, glutamine, and a precursor, analog, prodrug, and/or derivative thereof, as well as molecules that interact with arginosuccinate synthase and/or arginosuccinate lyase, and analogs, prodrugs and derivatives thereof, including salts, esters or prodrugs thereof.

In some embodiments, when the amino acid is included in the formulation, and the amino acid is the amino acid analog of a human or proteinogenic amino acid, such as an analog found in a plant or fungi, the stilbenoid compound and the caffeine, whether provided independently or as the second combination, may make up about 35% to about 50% by weight of the active portion by weight, such as in embodiments in which the active portion comprises no more than 12% by weight of the final formulation, or no more than 15% by weight of the final formulation. In some embodiments, when no amino acid is included in the formulation, the stilbenoid compound and the caffeine, whether provided independently or as the second combination, may make up about 15% to about 30% of the active portion by weight, such as in embodiments in which the active portion comprises up to about 20% by weight of the final formulation, or between about 4% by weight and up to about 15% or about 20% of the final formulation.

A representative example that provides at least the above described stilbenoid compound and the caffeine for the second combination is Purenergy™ (ChromoDex Inc., California, USA), which contains about 40-46% caffeine, and about 52-62% pterostilbene (e.g., trans form). When this is used for the second combination, about or up to about 100 mg may be included in a final formulation, when provided as an individual or single administration. In some embodiments, said amount may be about or up to about 50 mg when provided as an individual or single administration. In some embodiments, said amount may be about or up to about 25 mg when provided as an individual or single administration. Any of said amounts would be suitable for an individual oral dose or for a single oral administration, such as when the single oral administration or individual oral dose is in the amounts described herein, for example, about 1.5 g, or about 2 g, or about 2.2 g, or about 3 g, or about 4 g, more or less, or is about 60 ml, or about 90 ml, or about 100 ml, or more or less.

Unexpectedly, the described compositions having the amino acid, first combination and the second combination have been found to have a robust and unexpected synergistic effect, greater than the activity of each. The magnitude of synergism as has been found with the described novel combination was not predicted.

In addition to at least the astragaloside compound, the ginsenoside compound, the stilbenoid compound, and the caffeine, the novel compositions described herein are, in one or more embodiments, provided in edible or oral form. In one or more embodiments, the edible and/or oral forms are modified sufficiently with one or more sweeteners and/or flavorants to be palatable and/or acceptable and/or enjoyable for oral administration. In one or more embodiments, the sweeteners and/or flavorants are included in compositions provided in a candy form.

In some embodiments, one or more additional active components are provided to compositions described herein, in which said compositions include at least one or more of the astragaloside compound, the ginsenoside compound, the stilbenoid compound, and the caffeine. In some embodiments, the compositions include at least one or more of the amino acids, the first combination and the second combination, or some variation thereof, with one or more additional actives. In some embodiments, one or more additional active components are provided to compositions described herein, in which said compositions also include the sweeteners and/or flavorants to provide the compositions in candy form. The additional active components provide further functionality to the compositions, including the compositions provided in candy form. Further active components include but are not limited to other bioactive components, such as other amino acids, and/or antioxidants, and/or proteins, and/or fatty components, and/or enzymes, and/or vitamins, and/or minerals, and/or extracts, etc., as non-limiting examples. Any of the additional active components may be included alone, or in any combination, providing another facet and function for a multi-faceted composition as described herein; the additional active components performing synergistically when provided with the compositions described herein (having at least the astragaloside compound, the ginsenoside compound, the stilbenoid compound, and the caffeine).

In one or more embodiments, the compositions described herein may further comprise a plant, herb, tree, and/or extracts thereof (e.g., extract from the fruit, seed, flower, bark, leaf, etc.) having one or more biologic actions when provided to or administered to a subject. For example, the composition may further comprise an extract from Crocus (genus), an extract of Crocus sativus (e.g., saffron), an extract of saffron. This extract when used as described herein may be provided as an extract that generally includes at least one or more of an active component, crocin, which is a dopamine reuptake inhibitor, and/or another active component, safranal, a serotonin reuptake inhibitor. Such an extract (and/or active components thereof) may be provided to further enhance function and capability of the compositions described herein. For example, it will provide further health benefits to a subject provided with the composition, including but not limited to reducing anxiety and/or symptoms associated with depression (without increasing appetite), increasing satiation, reducing hunger sensation (e.g., between meals), thereby providing other facets and functions, acting synergistically when provided with the compositions described herein (having at least the astragaloside compound, the ginsenoside compound, the stilbenoid compound, and the caffeine). The amount of crocus extract (or active ingredients thereof) in a single administration or individual serving of a composition described herein may be from about 10 mg to about 50 mg, or up to about 60 mg, or up to about 70 mg, or any range or amount therebetween. A total daily amount of the crocus extract (or active ingredients thereof) is often less than 100 mg, or may be less than 90 mg, or may be less than 80 mg, or may be less than 70 mg. In one or more embodiments, the amount of such an extract in a single dose of a composition described herein is less than an amount found to be used in studies with crocus extract alone for persons with stress and/or considered overweight, in which said doses were typically about 177 mg per day (from a liquid saffron extract, given in two capsules, each containing about 88 mg). In some embodiments, and for good synergistic benefits, the percentage of the crocus extract (or active ingredients thereof) in the active portion of the composition (i.e., comprising at least the astragaloside compound, the ginsenoside compound, the stilbenoid compound, and the caffeine) may be from about 15% and up to about 35%, or any range therebetween. Of course additional amounts may be provided, as needed or as desired. In representative examples, crocus extract was included in formulations described herein, in which the crocus extract was provided in amounts from between about 20 mg and 50 mg for a single administration or individual serving.

In addition or as an alternative, the compositions described herein may further comprise an extract from African mango, such as Irvingia gabonensis, (and/or active components thereof, such as from the seed). The extract and/or its active components include but are not limited to capabilities, such as reducing cholesterol and triglycerides, inhibiting adipogenesis, modulation of PPAR gamma and glycerol-3-phosphate dehydrogenase, and improving C-reactive protein, leptin and/or adiponectin levels with extended use. In compositions, the extract (and/or its active components) will provide further health benefits to a subject provided with the composition, including but not limited to improving satiation, providing appetite control, increasing thermogenesis and/or cellular metabolism, maintaining or improving resting (fasting) blood glucose levels. The amount of this extract (or active ingredients thereof) in a single administration or individual serving of a composition described herein may be from about 50 mg to about 200 mg, or any range or amount therebetween. A total daily amount of this extract (or active ingredients thereof) is often about 100 mg, or about 300 mg, or about 400 mg, or up to about 500 mg. In some embodiments, and for good synergistic benefits, the percentage of the African mango extract or Irvingia gabonensis extract (or active ingredients thereof) in the active portion of the composition (i.e., composition comprising at least the astragaloside compound, the ginsenoside compound, the stilbenoid compound, and the caffeine) may be about 15%, or about or up to about 20%, or about or up to about 25%, or any range therebetween. Of course additional amounts may be provided, as needed or as desired. In representative examples, this extract was included in formulations described herein, in which the extract was provided in amounts of up to about 12.5% for a single administration or individual serving as described herein, based on the total composition. For example, the extract may be provided as WellTrim (registered with Icon Group, LLC, Vermont, USA, and having 7% albumins from an extract from the African mango seed), which was, in various embodiments, provided to compositions so that an amount of WellTrim iG in the total composition was from a range of between about 100 mg and 200 mg for a single administration or individual serving.

In addition or as an alternative, the compositions described herein may further comprise an extract of Japanese arrowroot (e.g., genus, Pueraria, flowers and/or roots thereof, also known as kudzu) (and/or active components thereof, including useful polyphenolics, e.g., flavones, or flavonoids, or isoflavones, or isoflavonoids, such as daidzin, genistein, tectoridin, tectorigenin, 7-O-xylosylglucoside). The extract and/or its active components include but are not limited to capabilities, such as inhibiting mitochondrial aldehyde dehydrogenase, and/or elimination of blood acetaldehylde. In compositions, the extract (and/or its active components) will provide further health benefits to a subject provided with the composition, including reducing hangover-like symptoms and/or effects of excessive alcohol, reducing alcohol intake and/or effects of alcohol, and/or improving cognitive function. The amount of this extract (or active ingredients thereof, including the flavones or flavonoids) in a single administration or individual serving of a composition described herein may be from about 200 mg to about 650 mg, or any range or amount therebetween. A total daily amount of this extract (or active ingredients thereof, including flavones or flavonoids) is often up to about 250 mg, or up to about 350 mg, or about 500 mg, or up to about 700 mg, or up to about 1000 mg, or up to about 1300 mg. In some embodiments, and for good synergistic benefits, the percentage of the extract (or active ingredients thereof) in the active portion of the composition (i.e., composition comprising at least the astragaloside compound, the ginsenoside compound, the stilbenoid compound, and the caffeine) may be about 35%, or about or up to about 40%, or about or up to about 45%, or may be about 50%, or up to about 55%, or up to about 60%, or any range therebetween. Of course additional amounts may be provided, as needed or as desired. In representative examples, this extract was included in formulations described herein, in which the extract was provided in amounts of up to about 30% for a single administration or individual serving as described herein, based on the total composition. For example, the extract may be provided as an extract of the flower, and having not less than about 3%, or not less than 5% flavones or flavonoids or isoflavones, from an extract of the kudzu flower), which was, in various embodiments, provided to compositions so that an amount of the extract in the total composition was from a range of between about 350 mg to about 650 mg for a single administration or individual serving.

In addition or as an alternative, the compositions described herein may further comprise an extract from Dichrostachys glomerata, (and/or active components thereof, such as polyphenols from fruit pods). The extract or its active components include but are not limited to capabilities, such as scavenging free radicals, such as nitric oxide, and providing beneficial antioxidants activity, such as superoxide anion radical activity, and hydroxyl radical activity. In compositions, the extract (and/or its active components) will provide further health benefits to a subject provided with the composition, including but not limited to maintaining or improving resting (fasting) blood glucose levels, providing antioxidants, improving weight management, providing anti-hypertensive effects, and/or anti-bacterial effects. The amount of this extract (or active ingredients thereof, including the polyphenols) in a single administration or individual serving of a composition described herein may be from about 100 mg to about 400 mg, or any range or amount therebetween. A total daily amount of this extract (or active ingredients thereof) is often about 100 mg, or about 200 mg, or about 300 mg. In some embodiments, and for good synergistic benefits, the percentage of the extract of Dichrostachys glomerata (or active ingredients thereof, including the polyphenols) in the active portion of the composition (i.e., composition comprising at least the astragaloside compound, the ginsenoside compound, the stilbenoid compound, and the caffeine) may be about 25%, or about or up to about 30%, or about or up to about 35%, or may be about 40%, or up to about 45%, or any range therebetween. Additional amounts may be provided, as needed or as desired. In representative examples, this extract was included in formulations described herein, in which the extract was provided in amounts of up to about 15% for a single administration or individual serving as described herein, based on the total composition. For example, the extract may be provided as DyGlomera or DygloFit (registered with Gateway Health Alliances, Inc., California, USA, and having not less than 10% polyphenols from a solvent extract of the fruit pod of Dichrostachys glomerata), which was, in various embodiments, provided to compositions so that an amount of DygloFit in the total composition was from a range of between about 100 mg and 400 mg for a single administration or individual serving.

In addition or as an alternative, the compositions described herein may further comprise an extract from Myrica (genus) plant, or bayberry, or candleberry, or wax myrtle (and/or active components thereof, including useful polyphenolics, e.g., triterpenes and flavonoids, such as myricetin, or dihydromyricetin, obtained from the leaves or root bark). The extract and/or its active components include but are not limited to capabilities, such as potentiation of gamma-aminobutyric acid (GABA) receptor, inducing glutathione-S-transferase, scavenging free radicals, such as nitric oxide, and providing beneficial antioxidants activity, such as superoxide anion radical activity, and hydroxyl radical activity. In compositions, the extract (and/or its active components, including myricetin, or dihydromyricetin) will provide further health benefits to a subject provided with the composition, including but not limited to improving antioxidant activity, reducing hangover-like symptoms and/or effects of excessive alcohol, reducing alcohol intake, and/or improving cognitive function. The amount of this extract (or active ingredients thereof) in a single administration or individual serving of a composition described herein may be from about 150 mg to about 650 mg, or any range or amount therebetween. A total daily amount of this extract (or active ingredients thereof) is often about 150 mg, or about 250 mg, or about 300 mg, or up to about 500 mg, or up to about 750 mg, or up to about 1000 mg. In some embodiments, and for good synergistic benefits, the percentage of the Myrica extract (or active ingredients thereof) in the active portion of the composition (i.e., composition comprising at least the astragaloside compound, the ginsenoside compound, the stilbenoid compound, and the caffeine) may be about 25%, or about or up to about 32%, or about or up to about 35%, or any range therebetween. Of course additional amounts may be provided, as needed or as desired. In representative examples, this extract was included in formulations described herein, in which the extract was provided in amounts of up to about 20% for a single administration or individual serving as described herein, based on the total composition. For example, the extract may be provided as dihydromyricetin, or as PoliNat (having 90% dihydromyricetin from an extract from bayberry leaves), which was, in various embodiments, provided to compositions so that an amount of the dihydromyricetin, or the PoliNat, in the total composition was from a range of between about 150 mg and 650 mg for a single administration or individual serving.

In addition or as an alternative, the compositions described herein may further comprise an extract of Sceletium tortuosum (and/or active components thereof, from dried plant material, and/or membranes thereof) provided to further enhance function and capabilities of the composition described herein. The extract or its active components include but are not limited to capabilities, such as blocking serotonin (5-HT) transporter, and inhibiting phosphodiesterase-4 enzyme. In compositions, the extract (and/or its active components) will provide further health benefits to a subject provided with the composition, including but not limited to reducing anxiety or stress, improving symptoms of depression and/or anxiety and/or threat. The amount of this extract (or active ingredients thereof) in a single administration or individual serving of a composition may be from about 1 mg to about 20 mg, or up to about 30 mg, or any range or amount therebetween. A total daily amount of the this extract (or active ingredients thereof) is often less than about 60 mg, or may be less than about 50 mg, or may be less than about 40 mg, or may be less than about 30 mg. In some embodiments, and for good synergistic benefits, the percentage of the Sceletium tortuosum extract (or active ingredients thereof) in the active portion of the composition (i.e., composition comprising at least the astragaloside compound, the ginsenoside compound, the stilbenoid compound, and the caffeine) may be about 1%, or about or up to about 10%, or about or up to about 12%, or any range therebetween. Additional amounts may be provided, as needed or as desired. In representative examples, Sceletium tortuosum extract was included in formulations described herein, in which the extract was provided in amounts of up to about 1%, or up to about 2% of the total composition, for a single administration or individual serving as described herein. For example, the extract may be provided as Zembrin (registered with HG&G Pharmaceuticals PTY LTD, Gauteng, South Africa), which was, in various embodiments, provided to compositions so that the amount of Zembrin in the total composition was from a range of between about 5 mg and 15 mg for a single administration or individual serving.

In addition or as an alternative, the compositions described herein may further comprise an extract from Aloe (genus), such as Aloe vera (and/or active components thereof, such as the resinous inner pulp, and/or the resinous yellow aloin). The extract or its active components include but are not limited to capabilities, such as relieving digestion, and/or improving glycemic response (acting as an antihyperglycemic agent). The amount of this extract (or active ingredients thereof) in a single administration or individual serving of a composition described herein may be from about 50 mg to about 150 mg, or any range or amount therebetween. A total daily amount of the this extract (or active ingredients thereof) is often about 100 mg, or about 150 mg, or about 200 mg, or up to about 300 mg. In some embodiments, and for good synergistic benefits, the percentage of the Aloe extract (or active ingredients thereof) in the active portion of the composition (i.e., composition comprising at least the astragaloside compound, the ginsenoside compound, the stilbenoid compound, and the caffeine) may be about 15%, or about or up to about 20%, or about or up to about 25%, or any range therebetween. Of course additional amounts may be provided, as needed or as desired. In representative examples, this extract was included in formulations described herein, in which the extract was provided as Aloe vera (pulp) in amounts of up to about 25% for a single administration or individual serving as described herein, based on the total composition.

In addition or as an alternative, the compositions described herein may further comprise a carotenoid, or carotenoid alcohol, such as zeaxanthin. In one or more embodiments, the composition may further comprise a xanthophyll, such as lutein. Combinations of the carotenoid, or the carotenoid alcohol, and the xanthophyll, such as lutein, may also be provided in compositions described herein. For example, such combinations of the carotenoid or the carotenoid alcohol, and/or the xanthophyll (e.g., zeaxanthin and/or lutein) are found in vegetables; and may be provided to compositions described herein to further enhance function and capabilities of the composition described herein, such as providing antioxidant activity, and improving eyesight and/or visual acuity and/or protection against high energy blue light. The amount of the carotenoid or the carotenoid alcohol, and/or the xanthophyll in a single administration or individual serving of a composition described herein may be from about 3 mg to about 30 mg, or any amount or range therebetween. A total daily amount of the this extract (or active ingredients thereof) is often less than about 100 mg, or may be less than about 80 mg, or may be less than about 60 mg, or may be less than about 40 mg. For good synergistic benefits, the percentage of at least one or both the carotenoid or the carotenoid alcohol, and/or the xanthophyll in the active portion of the composition (i.e., composition comprising at least the astragaloside compound, the ginsenoside compound, the stilbenoid compound, and the caffeine) may be about 1%, or about or up to about 10%, or any range therebetween. Additional amounts may be provided, as needed or as desired. In representative examples, the carotenoid or the carotenoid alcohol, and/or the xanthophyll was included in formulations described herein, in which the amount was up to about 2% of the total composition, for a single administration or individual serving as described herein. For example, the extract may be provided as lutein, or as Lutemax (registered with Omniactive Health Technologies, LTD, Mumbai, India, in which Lutemax 2020 includes at least 25% lutein and at least 5% zeaxanthin), which was, in various embodiments, provided to compositions so that the amount of Lutemax 2020 in the total composition was from a range of between about 10 mg and 90 mg for a single administration or individual serving.

In addition or as an alternative, the compositions described herein may further comprise dimethylaminoethanol (DMAE) or dimethylethanolamine (DMEA), or a bitartrate salt thereof, or analogs or derivatives thereof.

In addition or as an alternative, the compositions described herein may further comprise beta glucans (e.g., with D-glucose units having beta-1, 3 links and/or beta-1, 6 links, which are from cell wall of bacteria, fungi, yeast, seaweed, mushroom, and/or grains), or beta-D-glucose polysaccharides. The benefits of beta glucans, or related components having the beta glucan, may be provided to further enhance function and capabilities of the composition described herein. For example, beta glucans in a composition described herein will provide further health benefits to a subject provided with the composition. The health benefits include but are not limited to enhancements in immune function, reducing allergic response, lowering cholesterol, and improving bone and/or joint health. In one or more embodiments, beta glucans perform synergistically when provided with the compositions described herein (having at least the astragaloside compound, the ginsenoside compound, the stilbenoid compound, and the caffeine). The beta glucans and/or related components may be provided alone or in combination with one or more additional components, including but not limited to the amino acid(s). In one or more embodiments, beta glucans and/or related component(s) will be provided in an amount that is between about 13 mg and about 60 mg for a single administration of individual serving. The amount by weight of beta glucans and/or a related component may be between about 0.1% and 5%, based on the total weight of the composition. In some embodiments, and for good synergistic benefits, the percentage of beta glucans and/or a related compound or component in the active portion (i.e., comprising at least the astragaloside compound, the ginsenoside compound, the stilbenoid compound, and the caffeine) may be from about 2% and up to about 10%, or any range therebetween. Additional amounts may be provided, as needed or as desired. A representative example that may be included in a formulation described herein, to provide the beta glucans, is Polycan (registered to PeopleandTechnologies, LLC, in Texas, USA) in which the amount of beta glucans (from black yeast, specifically Aureobasidium pullulans) is about 13% in 150 mg. In various embodiments, Polycan was provided to compositions so that the amount of Polycan in the composition was from a range between about 100 mg and about 460 mg for a single administration or individual serving.

In addition or as an alternative, the compositions described herein may further comprise a hyaluronic acid, or biologically suitable form (e.g., salt form, or ester form, such as sodium hyaluronate, or a microbial fermented hyaluronic acid). The benefits of hyaluronic acid, or related components having hyaluronic acid, may be provided to further enhance function and capabilities of the composition described herein. For example, hyaluronic acid in a composition described herein will provide further health benefits to a subject provided with the composition. The health benefits include but are not limited to reducing joint pain, improving joint movement and/or articulation, altering extracellular matrices, including the skin (e.g., improving elasticity, volume, firmness, reducing wrinkles, etc.). In one or more embodiments, hyaluronic acid, or biologically suitable forms, perform synergistically when provided with the compositions described herein (having at least the astragaloside compound, the ginsenoside compound, the stilbenoid compound, and the caffeine, and/or with further additives, such as beta glucans). The hyaluronic acid, or biologically suitable forms, may be provided alone or in combination with one or more additional components, including but not limited to the amino acid(s). In one or more embodiments, hyaluronic acid, or biologically suitable forms, will be provided in an amount that is between about 5 mg and about 150 mg for a single administration of individual serving (higher amounts may provide better skin benefits). The amount by weight of hyaluronic acid, or biologically suitable form and/or a related compound or component may be between about 0.1% and 8%. In some embodiments, and for good synergistic benefits, the percentage of hyaluronic acid in the active portion (i.e., comprising at least the astragaloside compound, the ginsenoside compound, the stilbenoid compound, and the caffeine) may be from about 1% and up to about 30%, or any range therebetween (higher amounts may provide better skin benefits). Of course additional amounts may be provided, as needed or as desired. In representative examples, hyaluronic acid was included in formulations described herein, in which sodium hyaluronate in the composition was provided from a range between about 5 mg and 20 mg for a single administration or individual serving. Another representative example that may be included in a formulation described herein, to provide hyaluronic acid, is Hyabest (registered to Kewpie Kabushiki Kaisha DBA Q.P. Corporation, in Tokyo, Japan), containing hyaluronic acid and/or salts of hyaluronic acid. In various embodiments, hyaluronic acid was provided to the composition by including Hyabest in the composition from a range between about 25 mg and 150 mg for a single administration or individual serving. In some embodiments, hyaluronic acid (or biologically suitable forms) is initially agglomerized. Lower doses may be used (e.g., less than 100 mg) for better taste.

In addition or as an alternative, the compositions described herein may further comprise one or more glycoprotein and/or antibodies with or promoting activity in the immune system (e.g., inhibit tryptase enzymes, block binding of glycoproteins and/or trypsin inhibitor homologs to protease-activity recepter 2 (PAR2), and/or block binding of tryptase enzymes to PAR2). The benefits of such glycoproteins may be provided to further enhance function and capabilities of the composition described herein. For example, such glycoproteins in a composition described herein will provide further health benefits to a subject provided with the composition, such as enhancing immune function, reducing allergic responses. In one or more embodiments, these glycoproteins perform synergistically when provided with the compositions described herein (having at least the astragaloside compound, the ginsenoside compound, the stilbenoid compound, and caffeine). Such glycoproteins may be provided alone or in combination with one or more additional components, including but not limited to the amino acid(s). Such glycoproteins will be provided in an amount that is between about 40 mg and about 160 mg for a single administration of individual serving. In some embodiments, and for good synergistic benefits, the percentage of such glycoproteins in the active portion (i.e., comprising at least the astragaloside compound, the ginsenoside compound, the stilbenoid compound, and the caffeine) may be from about 5% and up to about 20%, or any range therebetween. Additional amounts may be provided, as needed or as desired. A representative example that may be included in a formulation described herein, to provide these glycoproteins, is Allerguard Express (registered to Nutragenesis, LLC, in Vermont, USA), in which Allerguard Express contains glycoproteins from quail eggs, specifically Coturnix japonica. In various embodiments, such glycoproteins were provided to the composition by including Allerguard in the composition from a range between about 40 mg and about 160 mg for a single administration or individual serving.

In addition or as an alternative, the compositions described herein may further comprise niacin (vitamin B3), or a component having niacin and/or performing in a manner representative of niacin, such as a vitamin B3 metabolite, and/or nicotinamide riboside. The niacin or component having niacin benefits may be provided to further enhance function and capabilities of the composition described herein. For example, niacin and/or its related components (e.g., vitamin B3 metabolite, and/or nicotinamide riboside) in a composition described herein will provide further health benefits to a subject provided with the composition. The health benefits include but are not limited to enhancements in aspects of cellular metabolism, in conversion of energy in the cell, and neural and/or cognitive improvements. In one or more embodiments, niacin and/or its related components (e.g., vitamin B3 metabolite, and/or nicotinamide riboside) perform synergistically when provided with the compositions described herein (having at least the astragaloside compound, the ginsenoside compound, the stilbenoid compound, and the caffeine). The niacin and/or related components may be provided alone or in combination with one or more additional components, including but not limited to the amino acid(s). In one or more embodiments, niacin, and/or related component(s) of niacin (e.g., vitamin B3 metabolite, and/or nicotinamide riboside) will be provided in an amount that is between about 25 mg and about 150 mg for a single administration of individual serving. The amount by weight of niacin and/or a related compound or component may be between about 1% and 10%, based on the total weight of the composition. In some embodiments, and for good synergistic benefits, the percentage of niacin and/or a related compound or component in the active portion (i.e., comprising at least the astragaloside compound, the ginsenoside compound, the stilbenoid compound, and the caffeine) may be from about 25% and up to about 67%, or any range therebetween. Of course additional amounts may be provided, as needed or as desired. A representative example that may be included in a formulation described herein, to provide the niacin and/or related components, is Niagen (registered to ChromaDex Inc., in California, USA). In various embodiments, niacin and/or related components were provided to the composition by including Niagen in the composition from a range between about 25 mg and 150 mg for a single administration or individual serving.

As used herein, the described composition may include any comparable derivative, analog, or prodrug or synthetic so-called equivalents that comprise the active portion. The composition for an individual or for a single administration may comprise a co-administration of any one or more of the described amino acid, first combination and second combination. The co-administration may occur by providing the components sequentially or concomitantly. The composition may also comprise a co-formulation of two or more of the described amino acid, first combination and second combination. In one or more embodiments, the co-administration comprises a formulation of the described components contained by the described amino acid, first combination and the second combination in one mix, the mix containing a sufficient amount for an individual or for a single administration or for a plurality of single administrations. Both the single administration and the plurality of single administrations may be stored at room temperature, having a long shelf life of over one year or for several years.

Representative amounts of the active portion in various exemplary embodiments are provided in TABLES 1-4, in which the active portion includes the amino acid, the first combination and the second combination for an individual administration. TABLE 1 represents the active portion provided as particles or granules for quick dissolving after sublingual administration. The amount of caffeine in an individual administration was about 20 mg, 21 mg, 22 g or 23 mg. TABLE 2 represents the active portion provided as a powder for quick dissolving in liquid for drinking, in which the amount of caffeine in an individual administration was about 61 mg, 62 mg, 63 mg, 64 mg, 65 mg, 66 mg, 67 mg, 68 mg, or 69 mg. TABLE 3 represents the active portion provided as a liquid form, in which the amount of caffeine in an individual administration was about 20 mg, 21 mg, 22 mg or 23 mg. TABLE 4 represents the active portion provided in a chewable form; the amount of caffeine in an individual administration was about 20 mg, 21 mg, 22 mg or 23 mg. Variations in caffeine amounts in these examples were dependent on the amount of caffeine provided in the second combination, which in these examples ranged from about 40% to 46%.

TABLE 2
Individual administration (4 g)

| Amount (mg) | % |
|---|---|
| 1000 | ~26.0 |
| 50 | ~1.3 |
| 150 | ~3.9 |
| 1150 | ~31.2 |

TABLE 1

Individual
administration (2 g)

| Active portion | Amount (mg) | % |
|---|---|---|
| amino acid | 500 | ~26.0 |
| first combination | 50 | ~2.6 |
| second combination | 50 | ~2.6 |
| Total Actives | 600 | ~31.2 |

TABLE 3

Individual
administration
(2 g in 3 oz.)

| Active portion | Amount (mg) | % |
|---|---|---|
| amino acid | 500 | ~26.0 |
| first combination | 50 | ~2.6 |
| second combination | 50 | ~2.6 |
| Total Actives | 600 | ~31.2 |

TABLE 4
Individual administration (2.2 g)

| Amount (mg) | % |
|---|---|
| 500 | ~23.2 |
| 50 | ~2.32 |
| 50 | ~2.32 |
| 600 | ~27.84 |

In any individual administration described herein, there may be up to about 1000 mg, or up to about 1100 mg, or up to about 1200 mg, or up to about 1300 mg, or up to about 1400 mg, or up to about 1500 mg, of active components (i.e., the active portion), in which the active components includes at least the astragaloside compound, the ginsenoside compound, the stilbenoid compound, and the caffeine, and optionally the amino acid, and/or additional additives. The active portion may be in a range from about 5 wt. % of the total composition, and up to about 25 wt. %, or from about 5 wt. % and up to about 30 wt. %, or from about 5 wt. % and up to about 35 wt. %, or from about 5 wt. % and up to about 40 wt. %, or from about from about 5 wt. % and up to about 45 wt. %, from about 5 wt. % and up to about 45 wt. %, or from about 15 wt. % of the total composition, and up to about 40 wt. %, or in any range therebetween. The total active portion in the composition will be lower in the absence of the amino acid. In the embodiments depicted, such as in TABLES 1-4, of the active components, generally the active portion included up to about 1000 mg of the amino acid (e.g., arginine, ornithine, citrulline, glutamine, and a precursor, analog, prodrug, and/or derivative thereof, as well as molecules that interact with arginosuccinate synthase and/or arginosuccinate lyase, and analogs, prodrugs and derivatives thereof), up to about 200 mg of the first combination, and/or up to about 200 mg of the second combination. Thus, when said active components (in any of the described amounts) are provided in an individual or a single administration (such as but not limited to a 2 g dose, 2.2 g dose or 4 g dose, as exemplified in the above tables), the remaining constituents in the composition will be comprised of excipients. Each individual or single administration may also be more that 2 g, 2.2 g, or 4 g, or may be less than 2 g, such that the amount of the one or more excipients will be adjusted as needed. In one or more embodiments, the individual or single administration is provided as a solid. In one or more embodiments, the individual or single administration is provided as a semi-solid (e.g., resinate, gel, gummy, wax, etc.). In one or more embodiments, the individual or single administration is provided as a candy having one or more sweeteners and/or flavorants.

The excipients may generally include one or more of at least one sugar alcohol, at least one organic acid, at least one alkalizing agent and/or pH buffering agent, at least one absorbent or disintegrant and/or glidant, and/or at least one effervescent agent. Representative and non-limiting examples of the sugar alcohol includes mannitol, xylitol, sorbitol, erythritol, pyranose derivatives, and furanose derivatives thereof. Representative and non-limiting examples of the organic acids include tartaric acid, malic acid acetic acid, benzoic acid, ascorbic acid, citric acid, sorbic acid, and hydrochloric acid, as well as salts thereof (often as sodium or potassium salts). Representative and non-limiting examples of the alkalinizing agent and/or pH buffering agent include sodium citrate, potassium citrate, sodium benzoate, potassium sorbate. Representative and non-limiting examples of the absorbent or disintegrant and/or glidant includes silica, such as a colloidal silica or amorphous colloidal silicon dioxide. The excipients may further include one or more sweeteners (e.g., sugar, sucralose, stevia), colorants (generally from natural sources), and/or one or more natural flavorings (e.g., chocolate, coffee, berry, cherry, grape, orange, peach, lemon, lemon lime, pineapple, mint, etc., and any combinations, thereof). The one or more excipients may serve generally as pharmaceutical carriers. Accordingly, compositions described herein for administration to a subject include the active portion and the one or more excipients or pharmaceutical carriers, some or many of which may serve as bulking agents, fillers, flavorants, and/or natural preservatives. In some embodiments, the compositions described include only natural components or ingredients, or only components or ingredients that are analogous to or derived from ingredients or components obtained from nature.

All components of the novel compositions described herein, including any excipients or pharmaceutical carriers, are considered Generally Recognized as Safe (GRAS) in accordance with the Federal Food, Drug and Cosmetic Act. The compositions described herein, including any excipients or pharmaceutical carriers, will generally not include products prepared by or produced by genetically modified organisms (GMO). In some embodiments, all components provided in the novel compositions described herein, and hence the novel compositions themselves, will be GMO free. In many embodiments, such as powder forms and liquids, the compositions will generally be free of or substantially free of cellulose, pectin, talc, or gelatin. In some embodiments, the composition may include pectin and/or gelatin, such as when forming resinates or possibly with some pressed tablets or wafers (e.g., gums, gummies, gels, etc.). In most embodiments, the composition will generally be free of or substantially free of polyesters and polyimides, methacrylate polymers or copolymers as well as cross-linked polymers. In most embodiments, the compositions will generally be free of or substantially free of surfactants and detergents. In most embodiments, the compositions will generally be free of or substantially free of chelators. In most embodiments, the composition will generally be free of or substantially free of prescription drugs, such as those synthesized without being a direct analog, derivative or prodrug of a naturally existing compound or molecule as would be understood by one of skill in the art. In most or preferred embodiments, the compositions will generally be free of or substantially free of glycols. In most or preferred embodiments, the compositions will generally be free of or substantially free of glycerols. In most or preferred embodiments, the compositions will generally be free of or substantially free of stearates. Some compositions in chewable form, for example, may contain a very small amount of stearate, said amounts generally less than 1% or less than 0.9% or less than 0.8% or less than 0.7% stearate based on an individual administration. Many embodiments will be free of oils. In some embodiments, such as some resinates and/or waxates, an oil may be included, in which the oil is typically from a natural source, such as a plant or seed source (e.g., palm oil, coconut oil). In some embodiments, the final formulation in an individual or single administration will be considered to have no carbohydrates from sugar. Some compositions may contain a fiber additive. Some compositions will contain no dietary fiber. In some embodiments, the final formulation, even when presented in a candy form, will be considered to have about or less than about 10 calories, or about 5 calories, with no calories from fat in the individual or single administration.

The excipients assist in providing the compositions in any of its various forms (e.g., solid or semi-solid forms, such as in a powder, losenge, tablet, gummy, candy, fast-dissolving particles or granules, chewable, gum, etc.). The excipients also facilitate transmembrane transport of the active portion for increases bioavailability and time of action of the active portion. In some embodiments, the excipients are selected in order to form a composition that dissolves rapidly in an aqueous environment or in the mouth. In some embodiments, the excipients are selected in order to form a solid composition. The solid composition may be in a dry form. The solid may include but is not limited to a tablet, beads, granules, particles, powder, hard candy, crystals, film, losenge, capsule, or wafer. In some embodiments, the excipients are selected in order to form a semi-solid composition. The semi-solid composition may be in any form, including but not limited to a resinate, a waxate, a gum, a soft candy, a film, or a wafer. In some embodiments, the excipients are selected in order to form a liquid, which may also include one or more liquid additives and/or water. For example, the composition may be provided in a concentrated form to be added to a liquid and served as a concentrated or as a ready-to-drink beverage product.

In some embodiments, the active portion is in an admixture. The admixture may further comprise one or more of the excipients and is then formed into a suitable dosing package for administration. Processing may include drying. Processing may including one or more further coating steps. Processing may include sieving through one or more suitable mesh sizes, such as for uniformity. The mesh size may be from about 20 mesh size (having an opening of 0.850 mm) and about 80 mesh size (having an opening of 0.180 mm) or may be 65 (having a 0.210 mm opening) or may be other than 65. Said administration packages may be for an individual or single administration or for a plurality of individual or single administrations (either pre-packaged individually or packaged in bulk). Generally, administration is oral, by mouth. The oral administration may include sublingual administration, in a form that is fast acting and disintegrates rapidly, as is understood by those of ordinary skill in the relevant art. With oral administration formulation may dissolve in a time period that is less than about 10 minutes, or less than about 5 minutes, or at or about 1 minute, or less than 1 minute, such as in range from about 1 second to 1 minute. The preferred dissolution time is less than 30 seconds. Thus, in one or more embodiments, the novel compositions described herein may be prepared in bulk and stored in bulk form or may be dosed into individual dosages for single administrations. Alternatively, the active portion may be stored separately, and then mixed with excipients before, during or after they are dispensed orally, to the mouth. With sublingual administration, the final formulation rapidly dissolves upon mixing with saliva and effectively delivers the active portion to the systemic circulation via absorption through the sublingual epithelium.

Preferably the active portion is absorbed and transported to the plasma quickly, resulting in a rapid onset of action. The sublingual composition may, in some embodiments, be in the form of a dry powder, or fine granules and/or crystals, as a rapidly disintegrating candy. In some embodiments, the powder may be a micronized powder.

In one embodiment, a dry or powder form is provided as granules or particles, in which a majority of the particles generally contain some of the active portion as well as some of the one or more excipients.

In some embodiments, the dry or powder form is provided in which particles either contain the active portion or contain the one or more excipients, providing said active portion containing particles independently from the excipient containing particles. In some embodiments, when there are the independently containing particles, these particles may have the same size or be of different sizes. In one embodiment, the excipient particles are larger than the particles of the active portion. This allows the small particles of active portion to coat the larger particle so that both sized particles are administered simultaneously. In some embodiments, some or all the particles will have a size capable of passing through a mesh, the mesh may have any size between about 20 mesh size (having an opening of 0.850 mm) and about 80 mesh size (having an opening of 0.180 mm). In some embodiments, excipient particles contain one charge and the active portion contain an opposite when particles are administered simultaneously (e.g., co-blended in the final formulation). The particles may be charged by blowing them into a chamber, which impart charge to the particles. Two oppositely charged chambers may be used. Or opposing charges may be obtained by using an acidic solution to make one set of particles, and a basic solution for the other set of particles. Charge may also be transferred through one or more charge devices or ion discharge devices (e.g., staticizer or destaticizer). When particles of the active portion and particles of the excipient(s) are oppositely charged, said particles may have a same average diameter or may have differing average diameters.

By altering the excipient composition of the particles or by having independently prepared particles, the dry form for sublingual administration may be designed to dissolve rapidly (e.g., less than 30 seconds or less than 1 minutes) or slowly (up to 15 minutes) in order to achieve a desired absorption profile and subsequent effect.

As an example, a rapidly disintegrating powder as candy is prepared by first mixing the alkalizing agent/pH buffering agent, organic acid, disintegrant, sweetener, and optional colorant with some of the sugar alcohol in a large drum. The first mixture if needed, is then passed through first screen (e.g., a #20 screen). The amino acid, first combination, second combination, at least one or more of the sugar alcohols, and natural flavorings are then blended in a second mixture, which may include initially passing the components through a delumper fitted with second screen (e.g., #16 screen). While blending the second mixture, the first mixture is added, which may include passing the first mixture through a delumper fitted with the second screen. The first and second mixture are thoroughly blended (e.g., for at least about 5 minutes). All or a portion may be removed, such as when preparing in large quantities, and this is reportioned back into the blender, followed by blending for a further period (e.g., up to about 15 minutes, or for more than 15 minutes). When prepared in bulk, individual administration portions may be removed and further packaged. In addition, packages may include enough to be able to dole out into a plurality of individual administration portions, as needed.

When the novel compositions is formed as a film, the film is generally flexible, having a thickness that is up to about 2 mm, and may be of any desired shape (circular, square, polygonal, oval, or some variation thereof). The film may have one or more layers. Generally, the film is for sublingual administration, containing both the active portion and accompanying excipients. The active portion and accompanying excipients may be in the same layer or may separate layers.

By altering the composition of the excipients, the film may be designed to dissolve rapidly (e.g., less than 30 seconds or less than 1 minutes) or slowly (up to 15 minutes) in order to achieve a desired absorption profile and subsequent effect.

When the novel compositions are formed in larger solid forms (e.g., candy, lozenge, tablet, capsule, wafer), these forms may include a solid or semi-solid, and may further comprise a complete blend of all the components (active portion and excipients), or may contain an active portion in, for example, a core or shell or in one or more specific layers of the solid form. With core/shell or layers there may be the same or differing disintegration rates. Said solid forms may also be further coated as is understood in the art (e.g., an enteric coating).

In some embodiments, a dosing regimen of the described novel combination may include one or more administrations or doses of the described novel compositions. Said administrations can be optimized by pharmacodynamic and pharmacokinetic data, thereby achieving a better effect and/or outcome in vivo. The effect and/or outcome of the described novel combinations will be improved as compared with the effect when only the amino acid or only the first combination or only the second combination are provided independently at the same administration amount or dosing. The dosing may include, for example, once per day, twice per day, or three times per day.

In a representative formulation for a rapidly dissolving candy, the formulation was provided as dry solids having the form of particles or fine granules. The formulation is in TABLE 5.

TABLE 5

Individual
administration (2 g)

| | Amount (mg) | % |
|---|---|---|
| Active portion | | |
| amino acid | 500 | 26.0 |
| first combination | 50 | 2.6 |
| second combination | 50 | 2.6 |
| Total Actives | 600 | 31.2 |
| Excipients | | |
| sugar alcohol(s) | | 56.2 |
| organic acid, pH buffer, disintegrant | | 7.7 |
| sweetener, natural flavoring, colorant | | 4.9 |
| Total Excipients | | 68.8 |

The active portion included 500 mg of citrulline as the amino acid, 50 mg of AstraGin™, as the first combination, and 50 mg of Purenergy™ as the second combination. The sugar alcohols were erythritol and xylitol, the organic acid was citric acid, the pH buffer was sodium citrate, the disintegrant was amorphous granulated colloidal silicon dioxide in the form of Aeropearl™ 300 (owned by AstraZeneca AB Corporation, Sweden), the sweetener was in the form of sucralose, the natural flavors were any one or more of chocolate, coffee, coconut, berry, cherry, grape, orange, orange-pineapple, peach, lemon, lemon lime, pineapple, mint, to name a few, and the colorant was naturally derived or naturally obtained, such as 1% beta carotene powder (with a gum acacia carrier). This rapidly dissolving energy candy was provided in a 2 g individual serving, had no fat, only 5 calories, no dietary fiber and no carbohydrates from sugar. The caffeine content per serving was less than 25 mg.

Another representative formulation was a powder form for dissolving in liquid, such as in 6 oz., or 7 oz., or 8 oz., or 9 oz., 10 oz. of liquid. The formulation is provided in TABLE 6.

TABLE 6

Individual
administration (4 g)

| Active portion | Amount (mg) | % |
|---|---|---|
| amino acid | 1000 | 26.0 |
| first combination | 50 | 1.3 |
| second combination | 150 | 3.9 |
| Total Actives | 1150 | 31.2 |
| Total Excipients | | 68.8 |

The active portion included 500 mg of citrulline as the amino acid, 50 mg of AstraGin™, as the first combination, and 150 mg of Purenergy™ as the second combination. The sugar alcohols were erythritol and xylitol, the organic acid was citric acid, the pH buffer was sodium citrate, the absorbant/disintegrant was amorphous granulated colloidal silicon dioxide in the form of Aeropearl™ 300, the sweetener was in the form of sucralose, the natural flavors were any one or more of chocolate, coffee, coconut, berry, cherry, grape, orange, peach, lemon, lemon lime, pineapple, mint, to name a few, and the colorant was a natural colorant when needed. Additionally, a fiber gum was included to provide 1 g of dietary fiber. This energy powder was provided in a 4 g individual serving, had no fat, only 10 calories, 1 g of dietary fiber and no carbohydrates from sugar. The caffeine content per serving was less than 70 mg.

In a representative formulation for a chewable wafer candy, the formulation was a chewable tablet and provided in TABLE 7.

TABLE 7

Individual
administration (2.2 g)

| | Amount (mg) | % |
|---|---|---|
| Active portion | | |
| amino acid | 500 | 23.2 |
| first combination | 50 | 2.32 |
| second combination | 50 | 2.32 |
| Total Actives | 600 | 27.84 |
| Excipients | | |
| sugar alcohol(s) | | 55.9 |
| organic acid, pH buffer, disintegrant | | 6.8 |
| sweetener, natural flavoring, colorant | | 8.8 |
| Total Excipients | | 70.9 |

The active portion included 500 mg of citrulline as the amino acid, 50 mg of AstraGin™, as the first combination, and 50 mg of Purenergy™ as the second combination. The sugar alcohols were erythritol and xylitol, the organic acid was citric acid, the pH buffer was sodium citrate, the disintegrant was amorphous granulated colloidal silicon dioxide in the form of Aeropearl™ 300, the sweetener was in the form of sucralose, the natural flavors were any one or more of chocolate, coffee, coconut, berry, cherry, grape, orange, peach, lemon, lemon lime, pineapple, mint, to name a few, and the colorant was naturally derived or naturally obtained, such as 1% beta carotene powder (with a gum acacia carrier). Additionally, less than 0.7% of a stearate was include, which may affect time release of the active portion. This chewable energy wafer candy was provided in a 2.2 g individual serving, had no fat, no dietary fiber and no carbohydrates from sugar. The caffeine content per serving was less than 25 mg.

Another representative formulation as depicted in TABLE 8 was a ready-to-drink liquid, such as in a 1 oz., or 2 oz., or 3 oz., or 4 oz. shot.

TABLE 8

Individual
administration (4 g)

| Active portion | Amount (mg) | % |
|---|---|---|
| amino acid | 500 | 26.0 |
| first combination | 50 | 2.6 |
| second combination | 50 | 2.6 |
| Total Actives | 600 | 31.2 |
| Total Excipients | | 68.8 |

The active portion included 500 mg of citrulline as the amino acid, 50 mg of AstraGin™, as the first combination, and 150 mg of Purenergy™ as the second combination. The sugar alcohols were erythritol and xylitol, the organic acid was citric acid, the pH buffer was sodium citrate, potassium sorbate and sodium benzoate, the absorbant/disintegrant was amorphous granulated colloidal silicon dioxide in the form of Aeropearl™ 300, the sweetener was in the form of sucralose, the natural flavors were any one or more of chocolate, coffee, coconut, berry, cherry, grape, orange, peach, lemon, lemon lime, pineapple, mint, to name a few, and the colorant was a natural colorant (naturally derived or naturally obtained). This energy drink was provided in a 3 oz. individual serving, had no fat, only 5 calories, and no carbohydrates from sugar. Caffeine per serving was 25 mg or less.

When any of the above formulations were provided to subjects in one single administration, each subject reported experiencing enhanced energy for more than four hours, or more than five hours, or more than six hours or up to eight hours. The subjects also reported having more mental clarity and improved memory that was not found with alternative products, including alternative products indicated for providing enhanced energy and/or performance.

Further representative formulations are depicted in TABLES 9-16, in which additional additives are provided, offering further functionality to the compositions described herein (i.e., compositions comprising at least the astragaloside compound, the ginsenoside compound, the stilbenoid compound, and the caffeine), and in which the caffeine content per serving was less than 25 mg, or less than 12 mg. When an amino acid is included, it is generally in the form of arginine, ornithine, citrulline, glutamine, and a precursor, analog, prodrug, and/or derivative thereof, as well as molecules that interact with arginosuccinate synthase and/or arginosuccinate lyase, and analogs, prodrugs and derivatives thereof (e.g., TABLES 9-14), or in the form of theanine (TABLES 15 and 16). The additional additives may be provided in any of the forms available and/or as extracted and/or as described herein, in which each additive provided the functionality as described herein. The formulations were provided in any form described herein, including but not limited to sprinkles, a liquid, drink (ready to drink), hard candy, pressed powder (e.g., sweat tart), and/or lollipop.

TABLE 9

Individual
administration (2 g)

| Active portion | Amount (mg) | % |
|---|---|---|
| amino acid | 500 | ~25 |
| astragaloside compound and | 50 | ~2.5 |
| ginsenoside compound | | |
| stilbenoid component and caffeine | 50 | ~2.5 |
| lutein (≧25%) and zeaxanthin (≧5%) | 80 | ~4 |
| Total Actives | 680 | ~34 |

TABLE 10

Individual
administration (90 ml)

| Active portion | Amount (mg) | mg/ml |
|---|---|---|
| amino acid | 500 | ~5.6 |
| astragaloside compound and | 50 | ~0.6 |
| ginsenoside compound | | |
| stilbenoid component and caffeine | 50 | ~0.6 |
| kudzu extract | 500 | ~5.6 |
| Total Actives | 1100 | |

TABLE 11

Individual
administration (2.5 g)

| Active portion | Amount (mg) | % |
|---|---|---|
| amino acid | 500 | ~20 |
| astragaloside compound and | 50 | ~2 |
| ginsenoside compound | | |
| stilbenoid component | 50 | ~2 |
| and caffeine | | |
| bayberry extract | 250 | ~10 |
| Total Actives | 850 | ~34 |

TABLE 12

| | Individual | |
|---|---|---|
| | administration (2 g) | |
| Active portion | Amount (mg) | % |
| amino acid | 250 | ~12.5 |
| astragaloside compound and | 25 | ~1.25 |
| ginsenoside compound | | |
| stilbenoid component and caffeine | 25 | ~1.25 |
| hyaluronic acid and/or salts of hyaluronic acid | 60 | ~3 |
| aloe extract | 100 | ~5 |
| Total Actives | 460 | ~23 |

TABLE 13

| | Individual | |
|---|---|---|
| | administration (2 g) | |
| Active portion | Amount (mg) | % |
| amino acid | 250 | ~12.5 |
| astragaloside compound and ginsenoside | 50 | ~2.5 |
| compound | | |
| stilbenoid component and caffeine | 50 | ~2.5 |
| Dichrostachys glomerata fruit pod | 200 | ~10 |
| extract (≧10% polyphenol)s | | |
| saffron extract | 20 | ~1 |
| Total Actives | 600 | ~28.5 |

TABLE 14

Individual
administration (2 g)

| Active portion | Amount (mg) | % |
|---|---|---|
| amino acid | 500 | ~25 |
| astragaloside compound and | 50 | ~2.5 |
| ginsenoside compound | | |
| stilbenoid component and caffeine | 25 | ~1.25 |
| African mango seed extract | 150 | ~7.5 |
| Total Actives | 725 | ~36.25 |

TABLE 15

| | Individual | |
|---|---|---|
| | administration (1.5 g) | |
| Active portion | Amount (mg) | % |
| amino acid | 50 | ~3.3 |
| stilbenoid component and caffeine | 25 | ~1.25 |
| astragaloside compound and | 50 | ~3.3 |
| ginsenoside compound | | |
| Sceletium tortuosum extract (dried plant) | 10 | ~0.7 |
| Total Actives | 130 | ~8.6 |

TABLE 16

| | Individual | |
|---|---|---|
| | administration (1.5 g) | |
| Active portion | Amount (mg) | % |
| amino acid | 40 | ~2.7 |
| astragaloside compound and ginsenoside | 50 | ~3.3 |
| compound | | |
| stilbenoid component and caffeine | 25 | ~1.25 |
| Crocus extract (flower) | 30 | ~2 |
| Total Actives | 145 | ~9.25 |

TABLE 17

| | Individual | |
|---|---|---|
| | administration (1.5 g) | |
| Active portion | Amount (mg) | % |
| astragaloside compound and | 50 | ~3.3 |
| ginsenoside compound | | |
| stilbenoid component and caffeine | 50 | ~3.3 |
| beta glucans (beta-D-glucose polysaccharides) | 150 | ~10 |
| sodium hyaluronic acid | 10 | 0.7 |
| Total Actives | 260 | ~17.3 |

Many of the formulations described herein were provided to subjects in one single administration, and each subject reported experiencing enhanced energy for more than four hours, or more than five hours, or more than six hours or up to eight hours, as well as the additional functionality provided by the additional additive. All subjects also reported having more mental clarity and improved memory that was not found with alternative products, including alternative products indicated for providing enhanced energy and/or performance.

In many embodiments, the novel composition will be provided at an effective amount or therapeutically effective amount, which refers to that amount of the novel composition on its whole which, when administered to a subject, such as one in need thereof, and is sufficient to effect at least the increase in energy. The novel composition should also provide, at an effective amount or therapeutically effective amount, an improvement in cognition. The novel composition should also provide, at an effective amount or therapeutically effective amount, an improvement in mental clarity. The novel composition should also provide, at an effective amount or therapeutically effective amount, an improvement in memory. Said effective amounts are as previously described for each of the components, which together are provided in a final formulation containing at least the active portion comprising the amino acid, the first combination and the second combination. The effective amounts also include administration of a final formulation containing at least the active portion comprising the amino acid, the first combination and the second combination, and at least one excipient. The effective amounts also include an administration of a final formulation containing at least the active portion have the amino acid, the first combination and the second combination, and more than one excipient. The administration is generally as a single or individual administration comprising all of the said active portion (at least the amino acid, first combination and second combination) with or without additional excipient(s) in the formulation. The administration may be once per day. The administration may be twice per day. Generally the administration is not more than three times a day since energy and/or performance (e.g., mental performance, cellular performance, physical performance) is effectively extended for up to four hours, or may be extended for up to five hours, or up to six hours, or up to seven hours or up to eight hours. Thus, a single or individual administration may be repeated two to three times per day.

The amount that constitutes a “therapeutically effective amount” will vary depending on the exact composition, the subject (e.g., age, health, weight), but can be determined routinely by one of ordinary skill in the art having regard to his own knowledge and to this disclosure. In some embodiments, the novel composition may also be provided prophylactically or preventatively or protectively.

The formulations may conveniently be presented in unit dosage form or otherwise (e.g., in bulk) and may be prepared by those methods known in the field. The amount of active ingredient which can be combined with additional components and/or a carrier material to produce a single dosage form will vary depending upon the host being treated, the particular mode of administration, and other factors. The amount of active portion that can be combined with the one or more excipients to produce a single or individual administration will, in many embodiments, generally be that amount of the active portion that produces the effect, such as improving energy. In some embodiments, this amount of the active portion will range from about 1% to about 50% of the total formulation, or from about 5% to about 40%, or from about 10% to about 35%, or any amount or range of amounts therein when provided in a dry form (solid or semi-solid).

Also provided are kits including one or more novel compositions described herein. A kit may include one or more additional agents or compounds with the described novel compositions described herein. The kit may include instructions for use. When there are a plurality components, the components may be provided in different containers. The kit may be compartmentalized to receive the one or more containers in close confinement. Illustrative examples of containers for said kits include, but are not limited to, small glass containers, plastic containers, composite containers, straw-shaped plastic or paper containers, strips of plastic or paper, etc. Containers may be those that allow a worker or user to efficiently transfer components or accompanying reagents from one compartment to another. Such containers may also be ones that will accept a compound or compositions described herein, and/or may accept a resuspending solution. Said compositions being in any of a powder (e.g. a lyophilized powder), precipitate, gel, or liquid form, as examples. Compositions described herein or one or more of the components that make up the described novel compositions may be provided in the same or different forms in a single kit, and may be provided in the same or different containers.

Embodiments described herein include providing said novel compositions to a subject or to subjects. A subject may be a mammal, including an animal or other multicellular organism. A subject may be a human. A subject may be an animal, such as a pet or farm animal.

As used herein and in the appended claims, the singular forms “a,” “and,” and “the” include plural referents unless the context clearly dictates otherwise. Thus, for example, reference to “an agent” or to “a composition” includes a plurality of such agents or compositions, and equivalents thereof known to those skilled in the art, and so forth. It is understood that “comprising” (and related terms such as “comprise” or “comprises” or “having” or “including”) is not intended to exclude embodiments wherein, for example, any composition of matter, composition, method, or process, or the like, described herein may “consist of” or “consist essentially of” the described features.

Although representative processes and articles have been described in detail herein, those skilled in the art will recognize that various substitutions and modifications may be made without departing from the scope and spirit of what is described and defined by the appended claims.

1. A composition for oral administration having an active portion comprising:
an amino acid in an amount between about 5% and 30% of the composition based on weight of the composition, the amino acid understood to have anabolic properties, the amino acid selected from one or more of the group consisting of: (i) an amino acid from the group consisting of arginine, ornithine, citrulline, glutamine; and (ii) an amino acid precursor, analog, or derivative thereof understood to have anabolic properties;
a first combination in an amount that is not more than 10% of the composition based on weight of the composition, the first combination comprising at least an astragaloside compound and a ginsenoside compound, wherein the astragaloside compound and the ginsenoside compound are in a blend and each make up between about 40% to 50% of the first combination, and, wherein, in the first combination, the astragaloside compound is either in a higher amount than the ginsenoside compound or is substantially in a same amount as the ginsenoside compound, and wherein, when the astragaloside compound and the ginsenoside compound together make up less than 100% by weight of the first combination, a filler is included in the first combination; and
a second combination in an amount that is not more than 10% of the composition based on weight of the composition, wherein the second combination is provided as a combination of a stilbenoid compound and caffeine, wherein the stilbenoid compound and the caffeine when combined are in a molar ratio in a range from 1.2:0.8 to 0.8:1.2,
wherein the active portion comprises up to 40% of the composition based on weight of the composition.

2. The composition of claim 1, wherein the composition is provided in a form for oral administration, and wherein a single individual serving of the composition for oral administration has an amount of caffeine that is 25 mg or less.

3. The composition of claim 1, wherein the astragaloside compound is extracted from Astragalus membranaceus, including variety mongholicus.

4. The composition of claim 1, wherein the ginsenoside compound is extracted from Panax natoginseng.

5. The composition of claim 1, wherein the composition is in a form for oral administration, the form selected from any one or more of the group consisting of dry form, resinate, liquid, and gel, and.

6. (canceled)

7. (canceled)

8. The composition of claim 1, wherein the composition further comprises a plurality of excipients, the excipients selected from the group of sweetener, sugar alcohol, flavorant, colorant, disintegrant, pH buffering agent, organic acid, and effervescent agent.

9. The composition of claim 1, wherein the stilbenoid compound is pterostilbene.

10. (canceled)

11. (canceled)

12. (canceled)

13. (canceled)

14. (canceled)

15. The composition of claim 1, wherein the composition is provided in a form for oral administration, and wherein the first combination in a single individual serving of the composition for oral administration is in an amount that is between about 1 wt. % and 4 wt. % based on the weight of the composition.

16. The composition of claim 1, wherein the composition is provided in a form for oral administration, and wherein the second combination in a single individual serving of the composition for oral administration is in an amount that is between about 0.5 wt. % and 5 wt. % based on the weight of the composition.

17. (canceled)

18. (canceled)

19. The composition of claim 1, wherein the second combination is provided as a co-crystallized form comprising the stilbenoid compound and the caffeine.

20. The composition of claim 1, wherein the composition is provided as any one or more of a candy, drink, pressed powder, gummy, chewable tablet, dissolving particles, and gum.

21. (canceled)

22. (canceled)

23. A method of use of a composition comprising an active portion and a plurality of excipients, the method comprising:
administering orally to a subject an effective amount of the composition, the active portion comprising:
an amino acid in an amount between about 2% and 30% of the composition based on weight of the composition, the amino acid understood to have anabolic properties, the amino acid selected from one or more of the group consisting of: (i) an amino acid from the group consisting of arginine, ornithine, citrulline, glutamine; (ii) an amino acid precursor, analog, or derivative thereof understood to have anabolic properties; and (iii) theanine;
a first combination in an amount that is not more than 10% of the composition based on weight of the composition, the first combination comprising a combination of an astragaloside compound and a ginsenoside compound, wherein the astragaloside compound and the ginsenoside compound are in a blend and each make up between about 40% to 50% of the first combination, and, wherein, in the first combination, the astragaloside compound is either in a higher amount than the ginsenoside compound or is substantially in a same amount as the ginsenoside compound, and wherein, when the astragaloside compound and the ginsenoside compound together make up less than 100% by weight of the first combination, a filler is included in the first combination; and
a second combination in an amount that is not more than 10% of the composition based on weight of the composition, wherein the second combination is provided as a combination of a stilbenoid compound and caffeine, wherein the stilbenoid compound and the caffeine when combined are in a molar ratio in a range from 1.2:0.8 to 0.8:1.2,
such that the composition in the effective amount provides sustained energy for up to 8 hours and, in the effective amount, contains an amount of caffeine that is less than 25 mg.

24. A composition for oral administration having an active portion comprising:
an astragaloside compound;
a ginsenoside compound;
a stilbenoid compound;
and caffeine,
wherein the composition when provided in an individual serving comprises:
up to 5% of the astragaloside compound in the individual serving based on the weight of the composition in the individual serving;
up to 5% of the ginsenoside compound in the individual serving based on the weight of the composition in the individual serving;
up to 5% of the stilbenoid compound in the individual serving based on the weight of the composition in the individual serving; and
up to 5% of the caffeine in the individual serving based on the weight of the composition in the individual serving,
and wherein, in the individual serving, the caffeine amount is less than 25 mg.

25. The composition of claim 24, wherein the composition further comprises an amino acid in an amount between about 2% and 30% of the composition based on weight of the composition in the individual serving, the amino acid understood to have anabolic properties, the amino acid selected from one or more of the group consisting of: (i) an amino acid from the group consisting of arginine, ornithine, citrulline, glutamine; (ii) an amino acid precursor, analog, or derivative thereof understood to have anabolic properties; and (iii) theanine.

26. (canceled)

27. (canceled)

28. (canceled)

29. (canceled)

30. (canceled)

31. The composition of claim 24, wherein in an individual serving, the composition comprises:
between 0.2% and 3% of the astragaloside compound in the individual serving based on the weight of the composition in the individual serving;
between 0.2% and 3% of the ginsenoside compound in the individual serving based on the weight of the composition in the individual serving;
between 0.2% and 3% of the stilbenoid compound in the individual serving based on the weight of the composition in the individual serving; and
between 0.2% and 3% of the caffeine in the individual serving based on the weight of the composition in the individual serving.

32. (canceled)

33. (canceled)

34. (canceled)

35. (canceled)

36. (canceled)

37. (canceled)

38. The composition of claim 24, wherein the active portion further comprises an extract of Crocus sativus comprising crocin and safranal, and wherein, in the individual serving, the amount of the Crocus sativus is between about 10 mg and 50 mg.

39. The composition of claim 24, wherein the active portion further comprises an extract of African mango seed, and wherein, in the individual serving, the amount of the African mango is between about 100 mg and 200 mg.

40. The composition of claim 24, wherein the active portion further comprises lutein and zeaxanthin, and wherein, in the individual serving, the amount of the lutein and zeaxanthin is between about 10 mg and 90 mg.

41. The composition of claim 24, wherein the active portion further comprises one or more of niacin and nicotinamide riboside, and wherein, in the individual serving, the amount of the one or more of niacin and nicotinamide riboside is between about 25 mg and 150 mg.

42. The composition of claim 24, wherein the active portion further comprises an extract of bayberry leaves or root bark, and wherein, in the individual serving, the extract of bayberry leaves or root bark includes dihydromyricetin in an amount between about 150 mg and 650 mg.
